(19) United States
(12) Patent Application Publication
(10) Pub. No.: US 2011/0213632 A1
(43) Pub. Date: Sep. 1, 2011

(54) ENVIRONMENTAL INFORMATION DOCUMENTING APPARATUS AND ENVIRONMENTAL INFORMATION DOCUMENTING METHOD

(75) Inventors: Yasuhiro HAMATSUKA, Yokohama (JP); Yuzo Hiroshige, Tokyo (JP)

(73) Assignee: Hitachi, Ltd.

(21) Appl. No.: 13/017,369

(22) Filed: Jan. 31, 2011

(30) Foreign Application Priority Data
Feb. 26, 2010 (JP) 2010-041285

(51) Int. Cl. G06Q 10/00

(52) U.S. Cl. 705/7.11

(57) ABSTRACT

An apparatus and a method for documenting environmental information are to be provided to facilitate environmental load evaluation of the whole life cycles of system products and to reduce the length of time required for evaluation. Environmental information is documented by computing the environmental load level of each of individual life cycles and their totals by estimating environmental load factors and the quantities thereof with a section for inputting indicators representing costs correlated to the environmental load levels and the scales of use of system products together with indicators representing the class of the system products and a section for storing evaluating conditions found in existing cases of such evaluation.

### BACKGROUND OF THE INVENTION

(1) Field of the Invention

The present information relates to system products such as information technology (IT) items, each combining multiple product items including hardware such as personal computers and software, for supporting documentation of environmental information, and more particularly for supporting documentation of information on environmental loads imposed by system products in their respective life cycles.

(2) Description of the Related Art

Environmental issues, of which citizens' awareness is heightening every year, are now challenging whole human society. In particular, as exemplified by the Kyoto Protocol and the EU's Energy using Products (EuP) among others calling for cutbacks on carbon dioxide emissions, which are presumably the cause of global warming, there is a worldwide urge for restraints on the generation of loads that adversely affect the environment.

Against this background, development of technology is undertaken for environmental load reductions at every stage of the life cycle of products from the extraction of raw materials to manufacturing and eventually discarding, even from the design stage for electrical household appliances and some other product categories, by such evaluation techniques as life cycle assessment, which covers all the load factors affecting the environment.

Furthermore, along with the expanding use of the Internet, the impact of system products on the consumption of energy and other physical resources came to be questioned and, to quantitatively assess the impact, life assessment techniques applicable to such products are now under development.

The life cycle assessment referred to above requires preparation of basic unit data for modeling environmental load evaluation items at each stage of the life cycle and converting these items into environmental loads. However, system products including IT products above all are made by combining multiple products including both hardware and software, and each product has complex and many life cycle stages. This entails the problem that a long time is taken to architect a model and prepare data for each product item.

To address this problem, Japanese Patent Application Laid-Open Publication No. 2007-94565 offers a technology that facilitates modeling and data preparation of an information communicating network for system products. However, this technology is intended for facilities and equipment for information communicating networks and, though its diversification to cover hardware of system products is possible, its adaptation to the whole life cycle is difficult, one of the most significant difficulties being the development of software designs.

### SUMMARY OF THE INVENTION

The present invention, attempted in view of these problems, is intended to provide an apparatus and a method for documenting environmental information to facilitate environmental load evaluation over the whole life cycles of system products and to reduce the length of time required for evaluation.

To address the problem noted above, the invention provides an environmental information documenting apparatus including: a storage unit that stores an evaluative information table, a transport information table, a product compositional information table, and an environmental load factor table, in each of which the cost and the scale of use of system products, each being a combination of plurality of hardware and/or software products, at different stages the life cycle thereof is assigned IDs sorted by product class, a shipping work information table in each record corresponds to one of the IDs, and a constituent elements information table, an evaluative information management table and a product evaluation result table; a control unit; and an input unit and an output unit that constitute user interfaces and performs communication with an external system.

The control unit includes:
a section that at least accepts from a user interface indicators representing the name of a product to be evaluated, the product field, the total cost of the product and the scale of use of the product, and extracts from the evaluative information table the record closest within a prescribed tolerance to the accepted product cost and scale of use,
a section that searches each table according to the ID of the extracted record, presents to the user interfaces the cost of the pertinent system product at each stage of the life cycle thereof, accepts a corrected input from the user and records the corrected cost,
a section that displays a product use environmental load factor screen on the user interface, presents information on the scale of use, the scale of use coefficient, and the initial value regarding factors including the number of man-hours worked, communicated data quantity, shift, consumed wattage and paper retrieved from the environmental load factor table and, after accepting a corrected input from the user, records the data,
a section that searches each record in the constituent elements information table and the product compositional information table matching the record of the extracted evaluative information table, computes the environmental load at each stage of the life cycle, and creates a product evaluation result table for each stage of the life cycle for each evaluation class of the environmental load and the cost and for each unit of totalization of the constituents, the system and the total, and
a section that outputs a product evaluation output table screen from the output unit, arranges on the screen a selection button for the name of product to be evaluated, the environmental load and the cost on the screen, accepts the input of the selection made therewith, and displays a graph of the environmental load or the cost at each stage of the life cycle and of the product use.

The control unit further has a section that reads out of the evaluative information table a record of the same field of product as the extracted record, computes a line form in which, out of dotted sequences plotted according to a coordinate system of (the scales of use and the stage-by-stage costs in the life cycle), only those satisfying a proportional relationship are left, computes the stage-by-stage cost of the life cycle according to the scales of use, and corrects the pertinent stage-by-stage cost of the life cycle.

The control unit has, in place of the section that displays a graph of the environmental load or the cost, a section that outputs an evaluation object selection table from the output unit, accepts on the screen inputting by the user of the evaluation object file name, the reference product and the object product, manages the same as stored in the table, outputs a product comparative evaluation output table in accordance with designation of an evaluation object file name by the user, and comparatively displays a graph of the environmental load or the cost of each of the reference product and the object product at each stage of the life cycle of the same according to selective inputting of the environmental load or the cost by the user.

The invention enables the quantity of input information required for environmental load evaluation of system products. This can contribute to enhancing the efficiency of the work which requires quantification of the greenhouse effect gas emission under the Carbon Footprint System and the product Clean Development Mechanism (CDM) among others.

### BRIEF DESCRIPTION OF THE DRAWINGS

The present invention will become fully understood from the detailed description given hereinafter and the accompanying drawings, wherein:

FIG. 1 schematically shows an environmental information documenting apparatus, which is an exemplary embodiment of one aspect of the present invention;

FIG. 2 charts the life cycle of a system product in which each block represents a unit of environmental load evaluation;

FIG. 3 is a flow chart of processing by the environmental information documenting apparatus;

FIG. 4 is a flow chart of processing to define product information;

FIG. 5 shows an example of screen for inputting definition of product information;

FIG. 6 shows an example of product field information table;

FIG. 7 shows an example of input information storage;

FIG. 8 is a flow chart of processing of cost estimation for each life cycle;

FIG. 9 shows an example of evaluative information table;

FIG. 10 shows an example of shipping work information table;

FIG. 11 shows an example of shipping work information storage;

FIG. 12 shows an example of transport information table;

FIG. 13 shows an example of transport information storage;

FIG. 14 shows an example of input screen regarding design and development;

FIG. 15 shows an example of input screen regarding shipping;

FIG. 16 shows an example of input screen regarding procurement;

FIG. 17 shows an example of constituent elements information of input screen regarding shipping;

FIG. 18 shows an example of transport means information table;

FIG. 19 shows an example of input screen regarding installation;

FIG. 20 shows an example of input screen regarding start-up;

FIG. 21 shows an example of input screen regarding maintenance;

FIG. 22 shows an example of input screen regarding collection;

FIG. 23 shows an example of input screen regarding recycling;

FIG. 24 shows an example of evaluative information management table;

FIG. 25 shows an example of product compositional information table;

FIG. 26 is a conceptual diagram of cost and scale;

FIG. 27 is a flow chart of cost estimation processing;

FIG. 28 shows an example of product compositional information table;

FIG. 29 shows an example of product compositional information storage;

FIG. 30 shows an example of system product information screen;

FIG. 31 shows an example of constituent elements information table;

FIG. 32 shows an example of environmental load factor table;

FIG. 33 shows an example of environmental load factor storage;

FIG. 34 shows an example of screen listing environmental load factors during product use (for business use);

FIG. 35 shows an example of screen listing environmental load factors during product use (for administration);

FIG. 36 shows an example of screen listing environmental load factors during product use (by customer);

FIG. 37 shows an example of processing to compute environmental loads;

FIG. 38 shows an example of product evaluation result table;

FIG. 39 shows an example of life cycle conditions;

FIG. 40 shows an example of environmental load-to-cost conversion table;

FIG. 41 shows an example of human work conversion factors;

FIG. 42 shows an example of product evaluation output table;

FIG. 43 shows an example of evaluation object selection table;

FIG. 44 shows an example of comparative evaluation management table;

FIG. 45 shows an example of comparative evaluation object product management table; and

FIG. 46 shows an example of product comparative evaluation output table.

### DESCRIPTION OF EXEMPLARY EMBODIMENTS

Exemplary embodiments of the present invention will be described below with reference to the accompanying drawings.

An IT product to be described as this embodiment is supposed, for the sake of simplicity of description, to comprise hardware including a personal computer (PC) and a server and software operating on the hardware for inventory management and other purposes, but the description will also hold true with other kinds of system products, such as an electric power control system, because they are also made up of hardware and software for controlling the hardware, such as a power plant.

### (1) Configuration of Environmental Information Documenting Apparatus

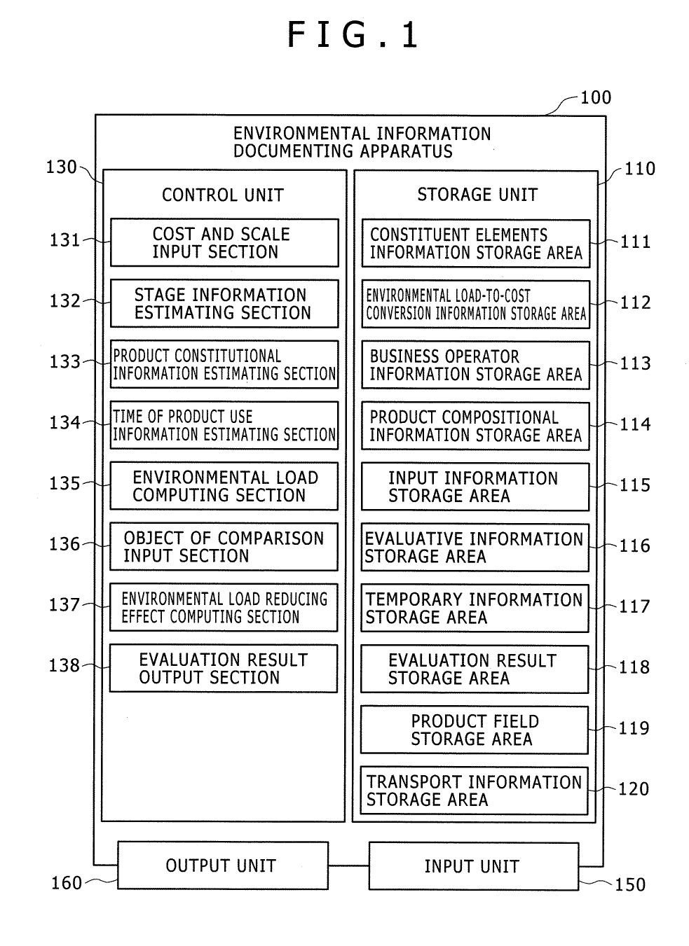

The configuration of the environmental information documenting apparatus, which is this exemplary embodiment, will be described with reference to FIG. 1. FIG. 1 schematically shows an environmental information documenting apparatus 100 embodying one aspect of the invention. As illustrated, the environmental information documenting apparatus 100 is provided with a storage unit 110, a control unit 130, an input unit 150 and an output unit 160.

The input unit 150 is supposed to have not only a keyboard, a mouse and the like for direct information inputting by the user of the environmental information documenting apparatus 100 but also, in some cases, the function of a communication unit that accepts various kinds of information from external systems via a network.

The output unit 160 is a display device or the like, which is supposed to have not only a function to display screens of user interface to the user of the apparatus but also a function of a communication unit to transmit various kinds of information to external systems via a network.

The storage unit 110 has a constituent elements information storage area 111, an environmental load-to-cost conversion information storage area 112, a business operator information storage area 113, a product compositional information storage area 114, an input information storage area 115, an evaluative information storage area 116, a temporary information storage area 117, an evaluation result storage area 118, a product field storage area 119 and a transport information storage area 120.

The constituent elements information storage area 111 stores constituent elements information which identify the environmental load, cost and attributes for computing the environmental load or the cost of each of the constituents making up a given system product.

The environmental load-to-cost conversion information storage area 112 stores environmental load-to-cost conversion information to specify conversion factors for computing environmental loads or costs from numerical values respectively corresponding to predetermined evaluation items.

The business operator information storage area 113 stores the pertinent business operator's sales of each work item and the environmental load level (the CO₂ emission here).

The product compositional information storage area 114 stores information to specify the product items constituting the system product.

The input information storage area 115 stores information inputted to specify the evaluation items regarding the cost and environmental load at individual stages of a life cycle including the design and development, shipping, procurement, transport, installation, start-up, use, maintenance, collection and recycling of the system product, and the numerical values of the costs and environmental loads of the respective evaluation items.

The evaluative information storage area 116 stores information created by the environmental information documenting apparatus 100 to specify the evaluation items regarding the cost and environmental load at individual stages of a life cycle including the design and development, shipping, procurement, transport, installation, start-up, use, maintenance, collection and recycling of the system product, and the numerical values of the costs and environmental loads of the respective evaluation items.

The temporary information storage area 117 stores information whose inputting has been accepted by the control unit 130, to be described in more detail afterwards, and information computed by the control unit 130.

The evaluation result storage area 118 stores information related to the result of computation by the control unit 130 to be described in more detail afterwards.

The product field storage area 119 stores information for distinguishing the field to which the system product belongs.

The transport information storage area 120 stores information for defining the transport means.

The control unit 130 has a cost and scale input section 131, a stage information estimating section 132, a product constitutional information estimating section 133, a time of product use information estimating section 134, an environmental load computing section 135, an object of comparison input section 136, an environmental load reducing effect computing section 137 and an evaluation result output section 138.

The cost and scale input section 131 processes acceptance via the input unit 150 inputting of information to specify the system product, which is the object, and storing of the same into the temporary information storage area 117.

The stage information estimating section 132 performs processing to compute from information stored in the temporary information storage area 117 and information stored in the evaluative information storage area 116 the numerical values of the evaluation items regarding the cost and environmental load at each stage of the life cycle of the object product on the basis of the numerical values of the cost and environmental load at individual stages of the life cycle including the design and development, shipping, procurement, transport, installation, start-up, maintenance and collection of the system product, and to store these values into the temporary information storage area 117. Then, via the output unit 160, it performs processing to output values in the temporary information storage area 117, to accept correction of any of the values outputted via the input unit 150, to rewrite values in the temporary information storage area 117, and to store the rewritten values into the input information storage area 115. Further, this section performs processing to compute again the numerical values of the evaluation items regarding the cost and environmental load at each stage of the life cycle of the object product from the information accepted by the temporary information storage area 117 and the cost and scale input section 131 and stored into the temporary information storage area 117, and to store the re-computed values into the temporary information storage area 117 and the evaluative information storage area 116.

The product constitutional information estimating section 133 performs processing to extract from the product compositional information storage area 114 compositional information on the constituents making up the system product from the information accepted by the cost and scale input section 131 and stored into the temporary information storage area 117 and the information stored in the evaluative information storage area 116, to alter the extracted product constitutional information on the basis of the information stored in the temporary information storage area 117 and to store the altered information into the temporary information storage area 117. Then, this section performs processing to output via the output unit 160 numerical values in the temporary information storage area 117, to accept correction of any of the values outputted via the input unit 150, to rewrite values in the temporary information storage area 117, and to store the rewritten values into the input information storage area 115 and the evaluative information storage area 116.

The time of product use information estimating section 134 performs processing to compute the wattage consumed by the electricity-consuming constituents from the information stored in the temporary information storage area 117 and the information stored in the constituent elements information storage area 111 outputted by the product constitutional information estimating section 133. Then, this section performs processing to extract from the information accepted by the cost and scale input section 131 and stored into the temporary information storage area 117 the information stored in the evaluative information storage area 116 the numerical values of the evaluation items regarding the environmental load, to output via the output unit 160 the values in the temporary information storage area 117, to accept correction of any of the values outputted via the input unit 150, to rewrite values in the temporary information storage area 117, and to store the rewritten values into the input information storage area 115 and the evaluative information storage area 116.

The environmental load computing section 135 performs processing to compute the environmental load from the information stored in the evaluative information storage area 116 according to year-by-year information stored in the environmental load-to-cost conversion information storage area 112 and the business operator information storage area 113, and to store the computed load into the evaluation result storage area 118.

The object of comparison input section 136 performs processing to output via the output unit 160 the results of the environmental load computation and relevant ones out of the list of evaluation results stored in the evaluation result storage area 118, to accept via the input unit 150 at least one object product as the reference product for comparative evaluation, and to output information that distinguishes the selected product or products to the temporary information storage area 117.

The environmental load reducing effect computing section 137 performs processing to output from the evaluation result storage area 118 to the temporary information storage area 117 the result of evaluation of the product distinguishing information stored in the temporary information storage area 117. Then it performs processing to compute, by using information stored in the temporary information storage area 117, information on the differential environmental load level of each object product relative to the reference product, and to store the computed information into the temporary information storage area 117.

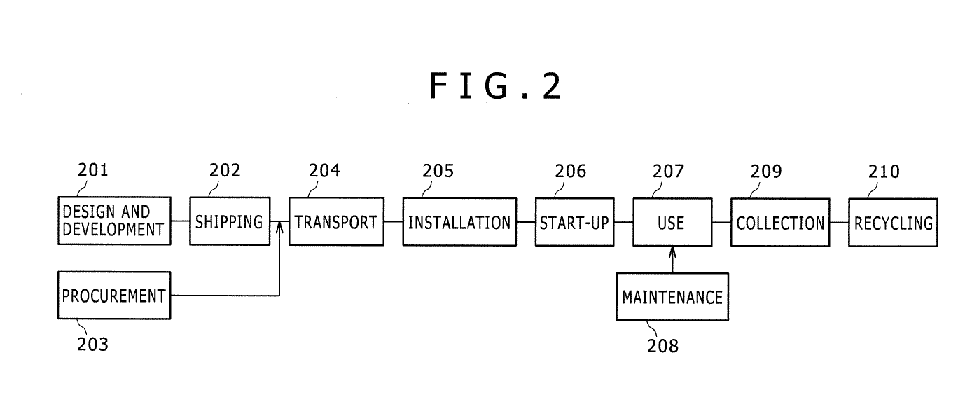

The evaluation result output section 138 displays via the output unit 160 differential information stored in the temporary information storage area 117 and the environmental loads and costs classified block by block of the life cycle in FIG. 2, each in a comparative graph of the reference product and object product and in tabulated numerical values, with respect to the reference product and object products selected by the object of comparison input section 136, and can also output the information in electronic data or in a paper medium form.

FIG. 2 here charts, in which each block represents a unit of environmental load evaluation, the life cycle of a system product in the exemplary embodiment of the invention.

The storage unit 110, the control unit 130, the input unit 150 and the output unit 160 described above may either be mounted wholly on a standalone apparatus or mounted in a decentralized manner on multiple apparatuses connected by Ethernet or otherwise and used for transmission and/or reception of information via a network as required.

It is also conceivable to implement the invention in a form in which the processing to be accomplished according to the invention to be described below is realized as a program to be executed by a computer and the program is stored in a computer-readable recording medium.

### (2) Outline of Flow of Processing by the Environmental Information Documenting Apparatus

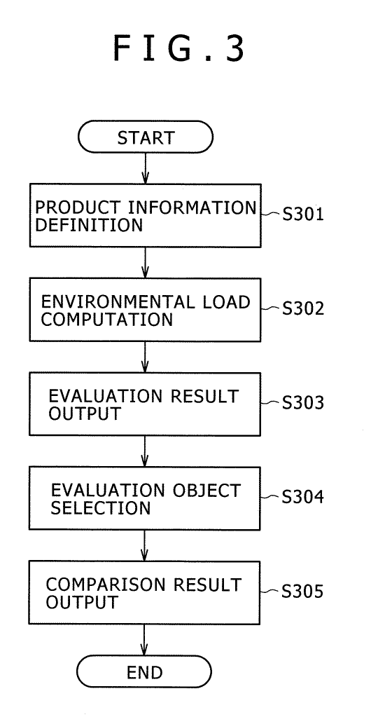

Next, FIG. 3 is a summarized flow chart of processing by the environmental information documenting apparatus 100 in this mode of embodying the invention. As charted in FIG. 3, the flow includes five steps of product information definition S301, environmental load computation S302, evaluation result output S303, evaluation object selection S304 and comparison result output S305. It has to be noted that at the steps of product information definition S301, environmental load computation S302 and evaluation result output S303, information regarding the environmental load factor of each product to be subjected to comparative evaluation regarding environmental information at the subsequent steps is inputted and defined to perform processing until environmental load evaluation of individual products, and processing of the reference product and the object product required for subsequent comparative evaluation at least is reiteratively performed. After that, evaluation object selection S304 is processed when documenting information on the environmental load reducing effect as compared between different products, such as between the reference product and an object product, and at comparison result output S305 the environmental load decrement and environmental load level at each stage of the product life cycle of the object product relative to the reference product is displayed via the output unit 160.

To add, information until storing into the evaluation result storage area 118 is held in the temporary information storage area 117 while being processed.

Operation of the environmental information documenting apparatus 100 in this mode of embodying the invention will be described below with reference to the steps of FIG. 3.

### (3) Processing of Product Information Definition

First, processing of product information definition S301 will be described. Here, the processing corresponds to the actions of the cost and scale input section 131, the stage information estimating section 132, the product constitutional information estimating section 133 and the time of product use information estimating section 134 of FIG. 1.

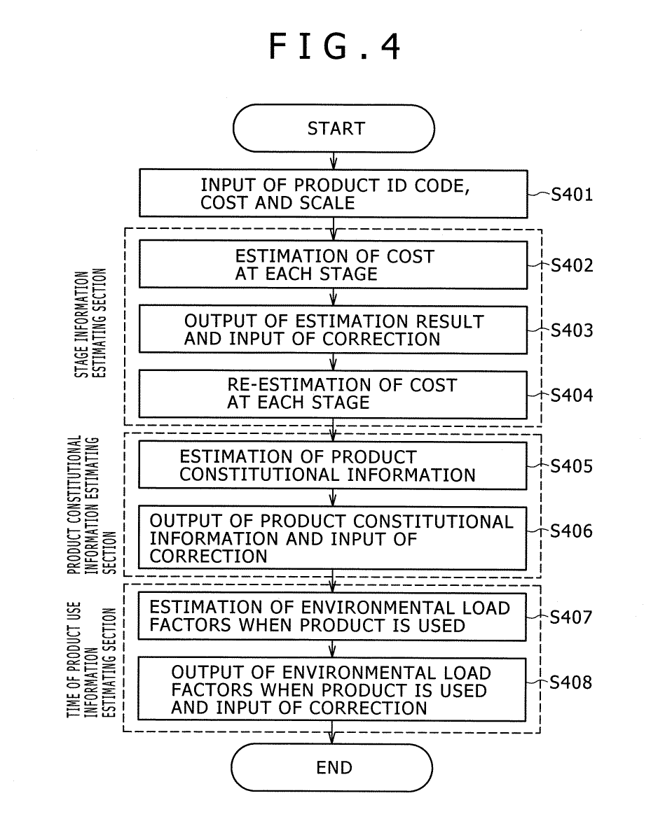

Incidentally, FIG. 4 is a flow chart of processing of product information definition S301.

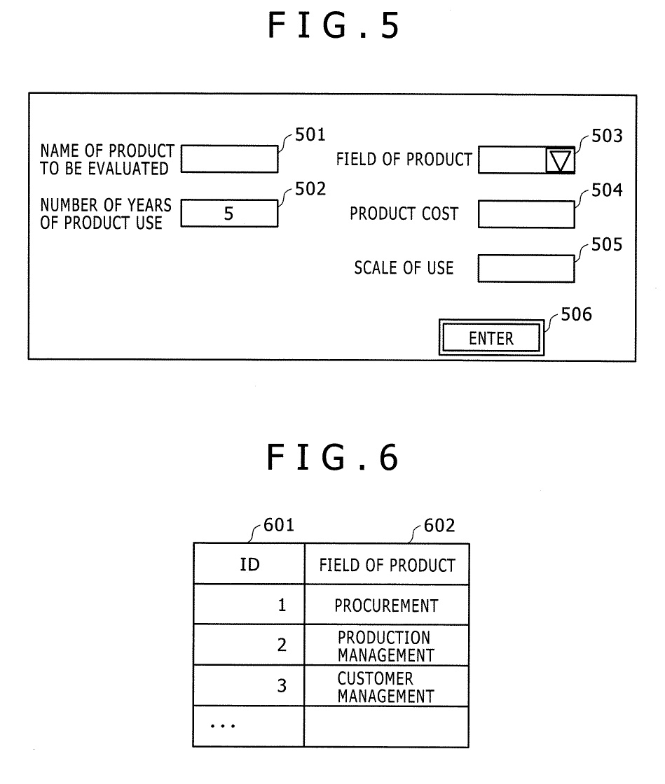

At step S401, the cost and scale input section 131 presents to the user a user interface expressed in a screen shown in FIG. 5 and accepts, as information on the product to be evaluated, inputting by the user of at least an identification (ID) code representing the field of product, the cost and the scale of use.

To explain FIG. 5, information on the product to be evaluated includes the name of product to be evaluated 501, the number of years of product use 502, the field of product 503, the product cost 504 and the scale of use 505. The field of product 503 here shall be selected by displaying in a pull-down menu or the like the field of product 602 in the product field information table stored in the product field storage area 119 shown in FIG. 6. For the scale of use 505, a numerical value representing a scale, such as the number of users of the system product or the number of terminals, is entered.

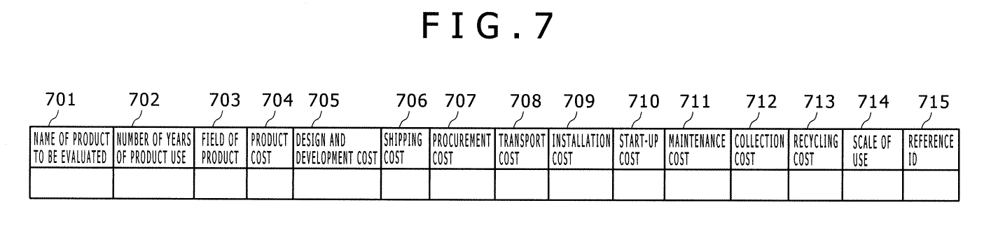

Next, when the enter button 506 is pressed, the name of product to be evaluated 501, the number of years of product use 502, the field of product 503, the product cost 504 and the scale of use 505 are respectively stored into the boxes of the name of product to be evaluated 701, the number of years of product use 702, the field of product 703, the product cost 704 and the scale of use 714 into the input information storage of the temporary information storage area 117 shown in FIG. 7.

Then, steps S402 through S404 are executed as processing by the stage information estimating section 132.

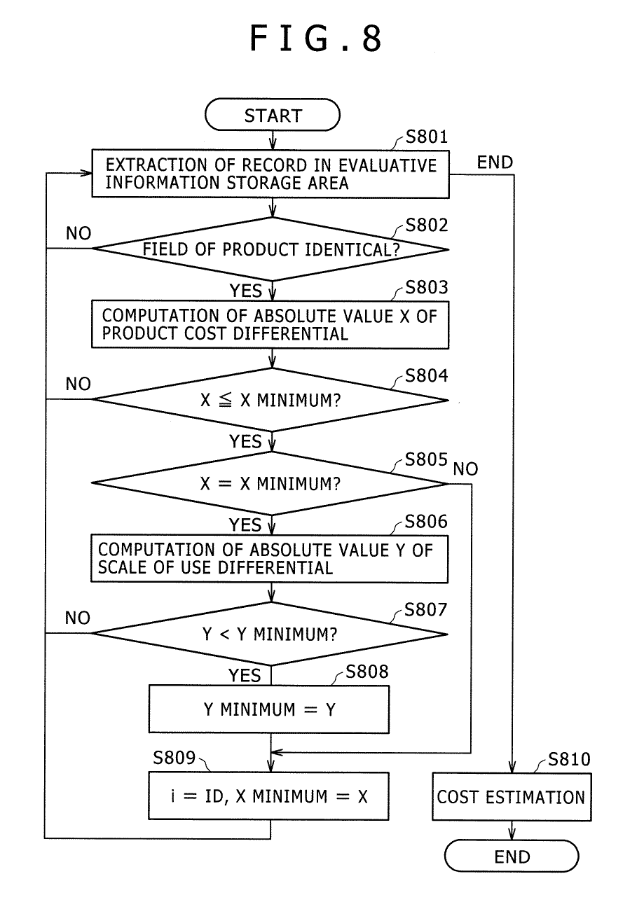

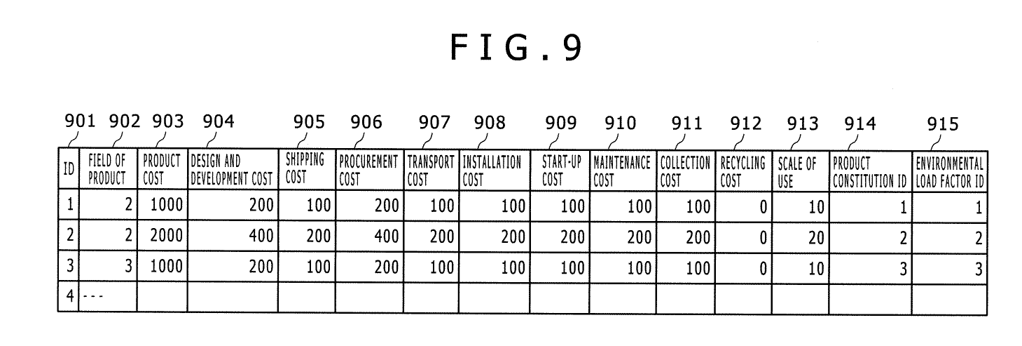

At step S402, by the processing from steps S801 through S809 charted in FIG. 8, a record in which the field of product 902 is entered as the field of product 703, the difference between the product cost 704 and the product cost 903 is the smallest and the difference between the scale of use 714 and the scale of use 913 is the smallest in the input information storage of the temporary information storage area 117 shown in FIG. 7 is extracted from the evaluative information table of the evaluative information storage area 116 shown in FIG. 9, and the ID 901 of the extracted record is stored into the reference ID 715 box. And by the processing at step S810, the design and development cost 705, the shipping cost 706, the procurement cost 707, the transport cost 708, the installation cost 709, the start-up cost 710, the maintenance cost 711, the collection cost 712 and the recycling cost 713 are computed by dividing the design and development cost 904, the shipping cost 905, the procurement cost 906, the transport cost 907, the installation cost 908, the start-up cost 909, the maintenance cost 910, the collection cost 911 and the recycling cost 912 in the extracted record by the product cost 903 to obtain the proportion of each and multiplying the product cost 704 by the obtained proportion, and the computed results are stored into the input information storage in the temporary information storage area 117.

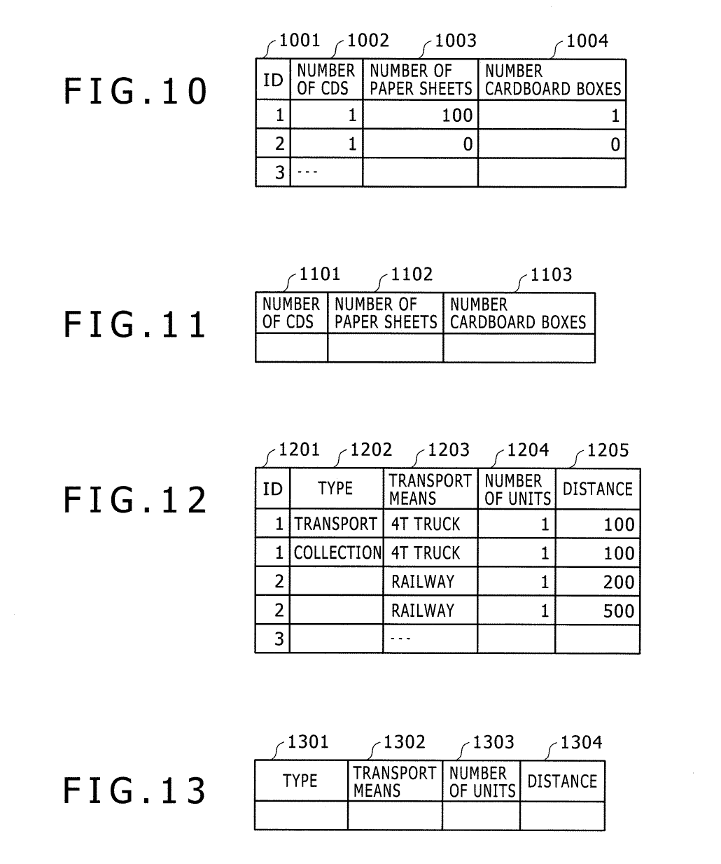

Further, a record in which the reference ID 715 and the ID 1001 coincide is extracted from the shipping work information table in the evaluative information storage area 116 shown in FIG. 10, and the number of CDs 1101, for which the number of CDs 1002 is entered, the number of paper sheets 1102, for which the number of paper sheets 1003 is entered, and the number of corrugated cardboard boxes 1103, for which the number of corrugated cardboard boxes 1004 is entered, are stored into the shipping work information storage in the temporary information storage area 117 shown in FIG. 11. Similarly, a record in which the reference ID 715 and the ID 1201 coincide is extracted from the transport information storage in the transport information table in the evaluative information storage area 116 shown in FIG. 12, and the type 1301, for which the type 1202 is entered, the transport means 1302, for which the transport means 1203 is entered, the number of units 1303, for which the number of units 1204 is entered, and the distance 1304, for which the distance 1205 is entered, are stored into the transport information storage in the temporary information storage area 117 shown in FIG. 13.

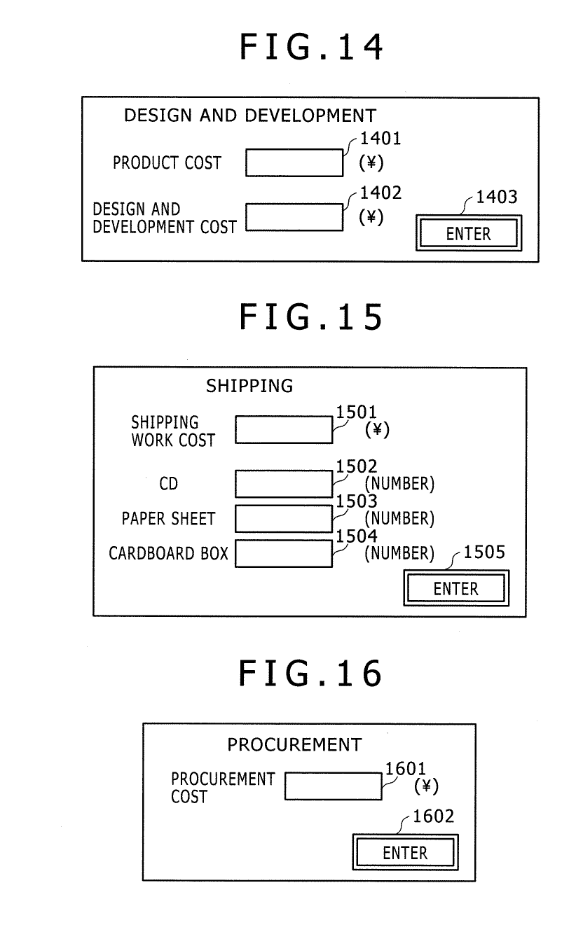

At step S403, information stored at the foregoing step into the input information storage, the shipping work information storage and the transport information storage in the temporary information storage area 117 is displayed via the output unit 160. It has to be noted, however, that inputting of display and corrections by the user is accepted according to the screens from FIG. 14 through FIG. 23.

To recapitulate the description in the order of pertinent drawings, at the design and development stage shown in shown in FIG. 14, the product cost 704 is displayed as the product cost 1401 and the design and development cost 705 is as the design and development cost 1402, and when the enter button 1403 is pressed after inputting corrections, processing to store the product cost 1401 as the product cost 704, the design and development cost 1402 as the design and development cost 705 is accomplished via the input unit 150.

At the shipping stage shown in FIG. 15, the shipping cost 706 is displayed as the shipping work cost 1501, the number of CDs 1101 is as the number of CDs 1502, the number of paper sheets 1102 is as the paper 1503, and the number of cardboard boxes 1103 is as the cardboard boxes 1504, and when the enter button 1505 is pressed after inputting corrections, processing to store the shipping work cost 1501 as the shipping cost 706, the number of CDs 1101 as the CD 1502, the number of paper sheets 1102 as the paper 1503 and the number of cardboard boxes 1103 as the cardboard 1504 is accomplished via the input unit 150.

At the procurement stage shown in FIG. 16, the procurement cost 707 is displayed as the procurement cost 1601, and when the enter button 1602 is pressed after inputting corrections, processing to store the procurement cost 707 as the procurement cost 1601 is accomplished via the input unit 150.

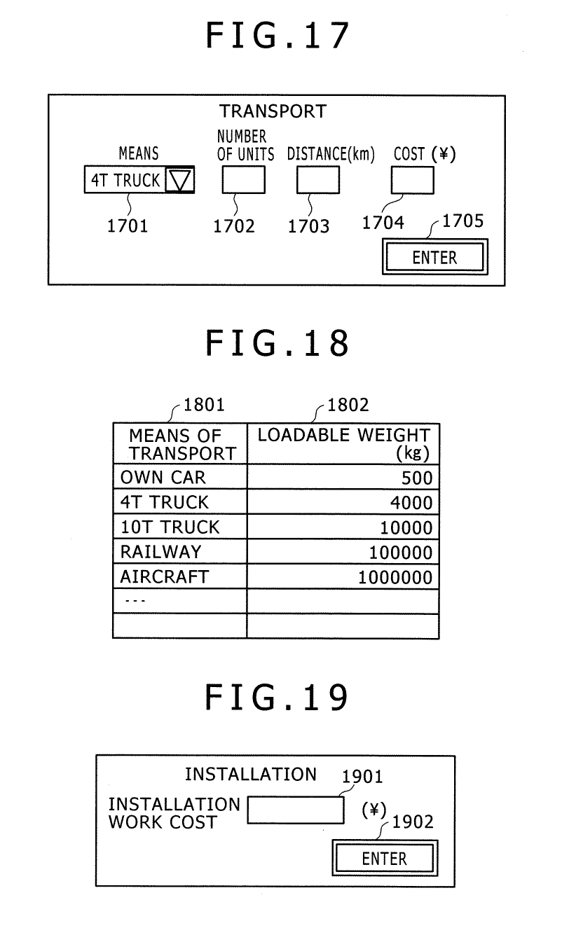

At the transport stage shown in FIG. 17, the number of units 1303 is displayed as the number of units 1702, the distance 1304 is as the distance 1703, and the means 1302 is as the transport means 1701, all as initial values from a record in which the type 1301 in the transport information storage is transport, and it is made possible to display and select as data of the pull-down menu the transport means 1801 in the transport means information table stored in the transport information storage area 120 shown in FIG. 18. Further, with the transport cost 708 being entered as the cost 1704, when the enter button 1705 is pressed after corrections are inputted, processing to store the transport means 1302 as the means 1701, the number of units 1303 as the number of units 1702, the distance 1304 as the distance 1703, and the transport cost 708 as the cost 1704 into a record in which the type 1301 is transport in the transport information storage is accomplished via the input unit 150.

At the installation stage shown in FIG. 19, the installation cost 709 is displayed as the installation work cost 1901, and when the enter button 1902 is pressed after corrections are inputted, processing to store the installation cost 709 as the installation work cost 1901 is accomplished via the input unit 150.

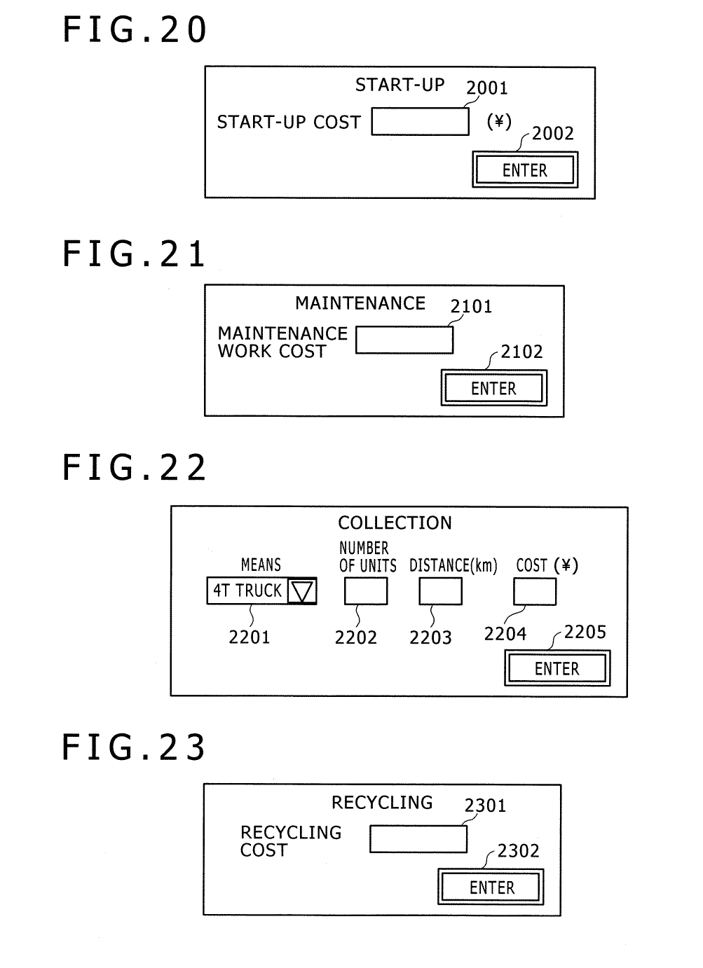

At the start-up stage shown in FIG. 20, the start-up cost 710 is displayed as the start-up work cost 2001, and when the enter button 2002 is pressed after corrections are inputted, processing to store the start-up cost 710 as the start-up work cost 2001 is accomplished via the input unit 150.

At the maintenance stage shown in FIG. 21, the maintenance cost 711 is displayed as the maintenance work cost 2101, and when the enter button 2102 is pressed after corrections are inputted, processing to store the maintenance cost 711 as the maintenance work cost 2101 is accomplished via the input unit 150.

At the collection stage shown in FIG. 22, the number of units 1303 is displayed as the number of units 2202, the distance 1304 is as the distance 2203 and the transport means 1302 is as the means 2201, all as initial values, from a record in which the type 1301 in the transport information storage is collection, and it is made possible to display and select as data of the pull-down menu the transport means 1801 in the transport means information table shown in FIG. 18. Further, with the collection cost 712 being entered as the cost 2204, when the enter button 2205 is pressed after corrections are inputted, processing to store the transport means 1302 as the means 2201, the number of units 1303 as the number of units 2202, the distance 1304 as the distance 2203, and the transport cost 708 as the cost 2204 into a record in which the type 1301 is collection in the transport information storage is accomplished via the input unit 150.

At the recycling stage shown in FIG. 23, the recycling cost 713 is displayed as the recycling cost 2301, and when the enter button 2302 is pressed after corrections are inputted, processing to store the recycling cost 713 as the recycling cost 2301 is accomplished via the input unit 150. It is to be noted that, as the recycling cost of each constituent item is separately prescribed, this is to comprise other costs than the prescribed.

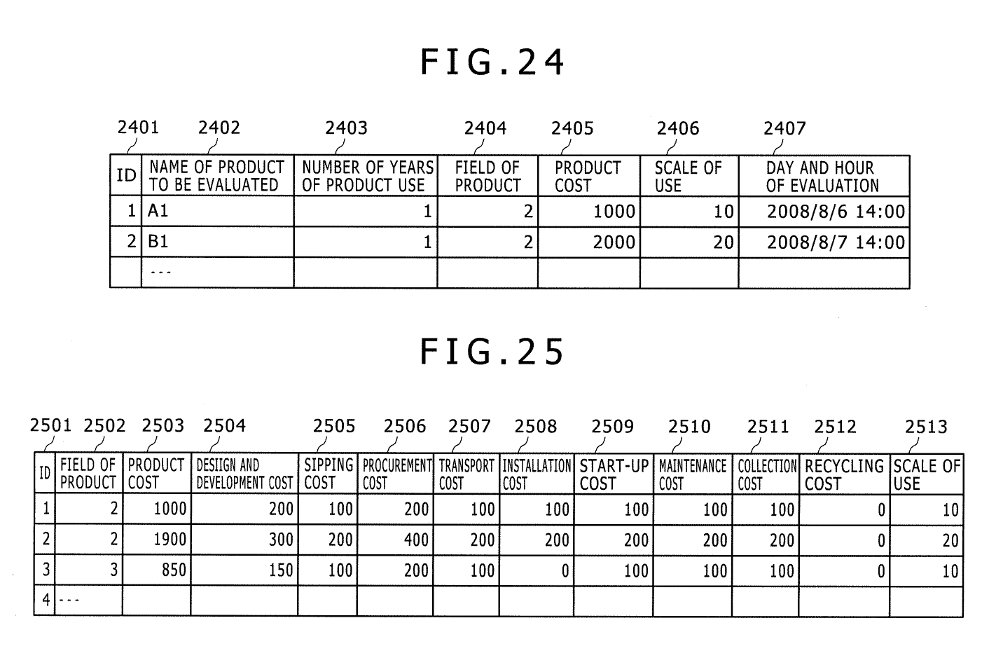

Then, to create a record for the evaluative information management table to be stored in the evaluation result storage area 118 shown in FIG. 24, an ID 2401 is issued. In accordance with the input information storage in the temporary information storage area 117 shown in FIG. 7, it is supposed that the name of product to be evaluated 2402 is the name of product to be evaluated 701, the number of years of product use 2403 is the number of years of product use 702, the field of product 2404 is the field of product 703, the product cost 2405 is the product cost 704 and the scale of use 2406 is the scale of use 714, and for the day and hour of evaluation 2407 the environmental information documenting apparatus 100 acquires the day and hour of the operation of the computer.

Further, a record is documented, in which the ID 2401 is supposed to be the ID 2501, in the input information table in the input information storage area 115 shown in FIG. 25. Then, it being supposed that the field of product 2502 is the field of product 703, the product cost 2503 is the product cost 704, the design and development cost 2504 is the design and development cost 705, the shipping cost 2505 is the shipping cost 706, the procurement cost 2506 is the procurement cost 707, the transport cost 2507 is the transport cost 708, the installation cost 2508 is the installation cost 709, the start-up cost 2509 is the start-up cost 710, the maintenance cost 2510 is the maintenance cost 711, the collection cost 2511 is the collection cost 712, the recycling cost 2512 is the recycling cost 713, and the scale of use 2513 is the scale of use 714, processing to store these items is accomplished.

Herein, the environmental load computation by the environmental information documenting apparatus 100 in this mode of embodying the invention includes, at the stage of design and development 201 in the product life cycle shown in FIG. 2 by way of example, computation of environmental loads including air conditioning and consumption of electricity and other energies involved in human work including the design and development of software. Therefore, if indicators according to the concept of Equation 1 below in which the scale of software is represented by the monetary value of sales in the items of environmental load totalization such as buildings for business operation and office work are made available, the environmental load in the design and development of each software product in the items of environmental load totalization can be computed by dividing the design and development cost of each software product by the indicator of Equation 1. To add, the environmental load of human work other than the design and development of software can be computed in accordance with the same principle.

(Indicator for environmental load computation)=(Monetary value of sales of all products belonging to items of totalization)/(Environmental load quantity of items of totalization) [Equation 1]

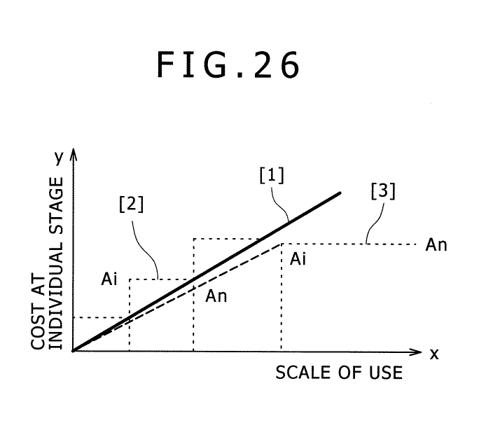

Further, since some environmental load factors, such as the consumed wattage, increase with the scales of use of the respective system products, each of such environmental loads is proportional to the scale of use. Therefore, the scale of use and the cost at individual stages also are in a proportional relationship as represented by [1] in FIG. 26. However, it has to be noted that there are two patterns of cost setting: in the pattern of [2] in FIG. 26 the charge is fixed until a certain quantity of use is reached and is phased up beyond that quantity, while in the pattern of [3] in FIG. 26 the charge is determined by the quantity of use until a certain quantity is reached and beyond that the charge is fixed. Thus, evaluation of the environmental load level merely on the basis of the cost as stated above would invite an error as large as the quantity is away from the linear relationship.

### (4) Processing of Stage-By-Stage Cost Correction in Life Cycle

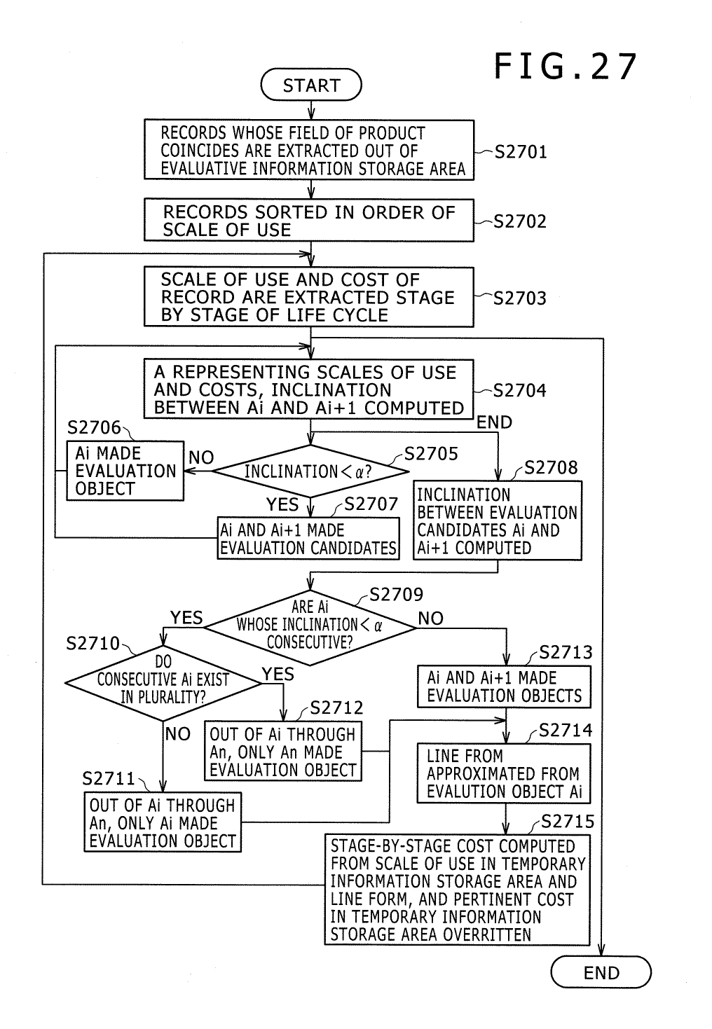

Then at step S404, every stage cost stored until the previous step except the procurement cost 707 and the recycling cost 713 in the input information storage in the temporary information storage area 117 is corrected according to the scale of use 714. This processing is accomplished at steps S2701 through S2715 charted in FIG. 27. First at step S2701, out of the evaluative information table in the evaluative information storage area 116 shown in FIG. 9, records whose field of product 902 coincide with the field of product 703 in the input information storage in the temporary information storage area 117 shown in FIG. 7 are extracted, and sorted at step S2702 in the order of the scale of use 913. At and after step S2703, the sorted records go through various steps of processing. For instance, according to the stage-by-stage costs in the life cycle including the design and development cost 904 and the scale of use 913, dotted sequences Ai of plane coordinates (the scales of use and the stage-by-stage costs in the life cycle) shown in FIG. 26 are set at step S2704, and in the processing from step S2705 through step S2713 sequences Ai which correspond to [2] and [3] in FIG. 26 are excluded according to the inclination between Ai and Ai+1. In the processing at step S2714, a line form is computed from the remaining dotted sequences Ai according to the scales of use and the stage-by-stage costs in the life cycle, and at step S2715, the stage-by-stage costs in the life cycle corresponding to the scale of use 714 are computed. Then according to the result of the foregoing, a stage-by-stage cost in the life cycle in the input information storage in the temporary information storage area 117, for instance the design and development cost 705, is overwritten. The processing from steps S2703 through S2715 so far described is accomplished on the design and development cost 705, shipping cost 706, transport cost 708, installation cost 709, start-up cost 710, maintenance cost 711 and collection cost 712 in the temporary information storage area to end the whole processing sequence. To add, a in FIG. 27 is the threshold of inclination, and in this embodiment of the invention it is supposed to be 0.1, though subject to variation.

### (5) Processing to Estimate Product Constitutional Information

Next, processing at step S405 and step S406 charted in FIG. 4 will be described as processing by the product constitutional information estimating section 133.

At step S405, out of a record in which the reference ID 715 and the ID 901 coincide with each other in the input information storage in the temporary information storage area 117 stored at the steps up to the previous one in the evaluative information table in the evaluative information storage area 116 shown in FIG. 9, the scale of use 913, the product constitution ID 914 and the environmental load factor ID 915 are extracted. And the ratio obtained by dividing the scale of use 714 by the scale of use 913 is computed.

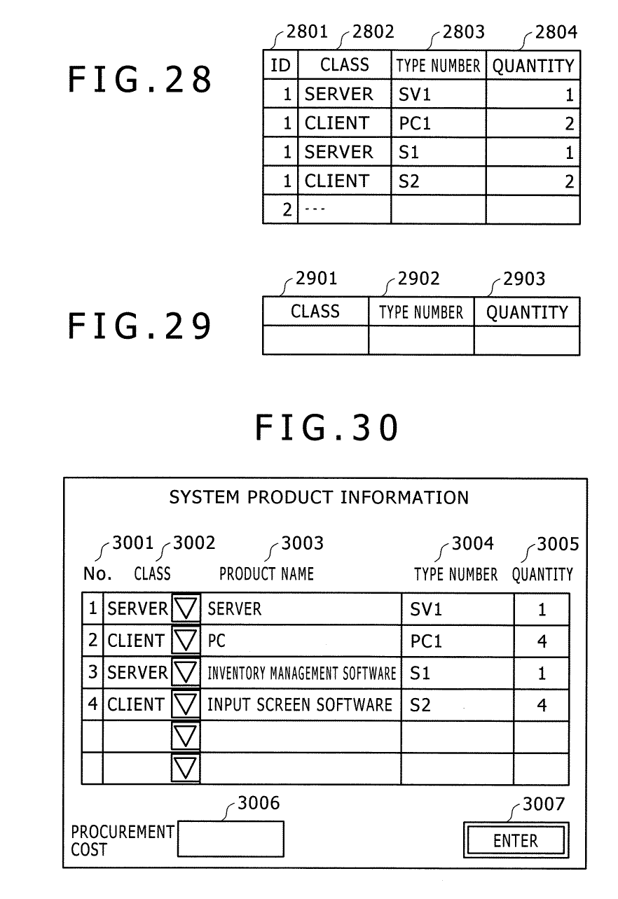

Then, a record in which the product constitution ID 914 and the ID 2801 coincide with each other is extracted out of the product compositional information table in the evaluative information storage area 116 shown in FIG. 28, and the product class 2901 is stored as the product class 2802, the type number 2902, as the type number 2803 and the quantity 2903 as the quantity 2804 into the product compositional information storage in the temporary information storage area 117 shown in FIG. 29.

Next, if the product class 2901 is a client in a record in the product compositional information storage in the temporary information storage area 117 shown in FIG. 29, the quantity 2903 is multiplied by the previously obtained ratio of the scale of use and updating is accomplished with an integer obtained by discarding the decimal fraction.

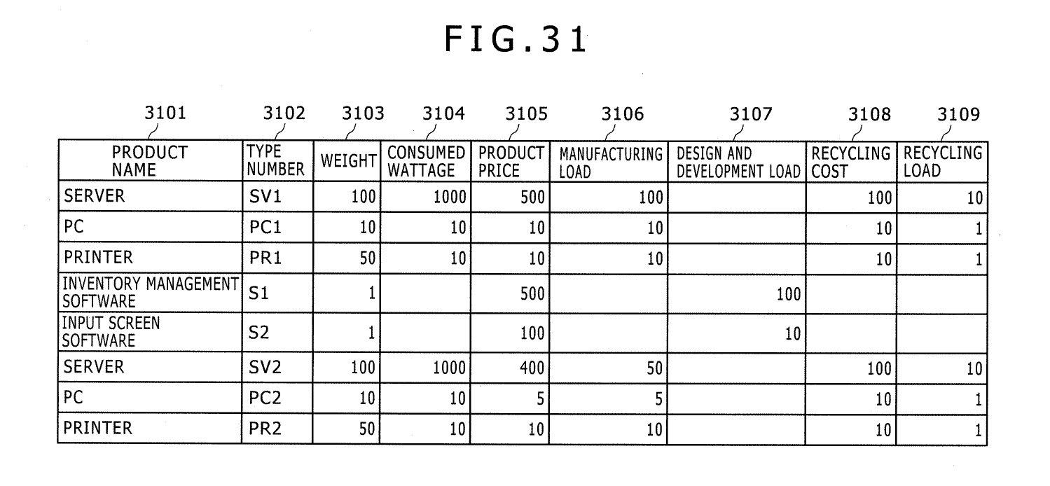

At step S406, data in the product compositional information storage are displayed via the output unit 160 on the system product information screen of FIG. 30. Nos. 3001 are assigned in the order of records, the values of the product class 2901, the type number 2902 and the quantity 2903 are displayed for the product class 3002, the type number 3004 and the quantity 3005, respectively. For the product name 3003, which is a record in the constituent elements information table in the constituent elements information storage area 111 shown in FIG. 31, the product name 3101 of the record in which the type number 3102 is the type number 2902 is displayed. For the product class 3002, either the server or the client can be selected, and for products to be used in proportion to the scale of use the client is set. For the procurement cost 3006, the procurement cost 707 is displayed.

After the enter button 3007 is pressed, the values of the product class 3002, the type number 3004 and the quantity 3005 are stored into the columns of the product class 2901, the type number 2902 and the quantity 2903, respectively. Then, in a record in the evaluative information management table shown in FIG. 24, the day and hour of evaluation 2407 acquires the ID 2401 of the latest record and, being identified with the ID 2801 in the product compositional information table in the evaluative information storage area 116 shown in FIG. 28, the product class 2901, the type number 2902 and the quantity 2903 in a record in the product compositional information storage in the temporary information storage area 117 shown in FIG. 29 are stored as the product class 2802, the type number 2803, and the quantity 2804, respectively. Also, the procurement cost 3006 is stored into the procurement cost 707 and at the same time it is stored into the procurement cost 2506 in the record whose ID 2501 coincides with the ID 2401 in the input information table.

### (6) Processing to Estimate, Output and Correct Environmental Load Factor at the Time of Product Use

Next, processing at step S407 and step S408 shown in FIG. 4 will be described as processing by the time of product use information estimating section 134.

At step S407, a record in which the environmental load factor ID 915 extracted at step S405 coincides with the ID 3201 in the environmental load factor table in the evaluative information storage area 116 shown in FIG. 3 is extracted and, into the environmental load factor storage in the temporary information storage area 117 shown in FIG. 33, the object of use 3202 is stored as the object of use 3301, the scale of use coefficient 3203 as the scale of use coefficient 3302, the number of man-hours worked 3204 as the number of man-hours worked 3303, the scale of use coefficient 3205 as the scale of use coefficient 3304, the communicated data quantity 3206 as the communicated data quantity 3305, the traffic means 3207 as the traffic means 3306, the scale of use coefficient 3208 as the scale of use coefficient 3307, the shift 3209 as the shift 3308, the scale of use coefficient 3210 as the scale of use coefficient 3309, the consumed wattage 3211 as the consumed wattage 3310, the scale of use coefficient 3212 as the scale of use coefficient 3311, and the paper 3213 as the paper 3312.

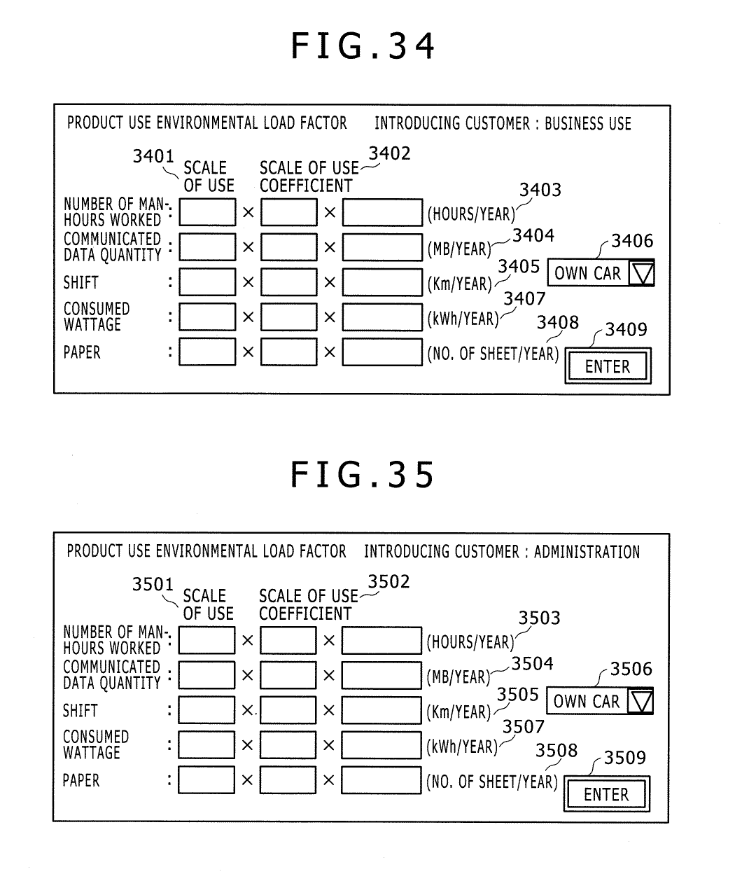

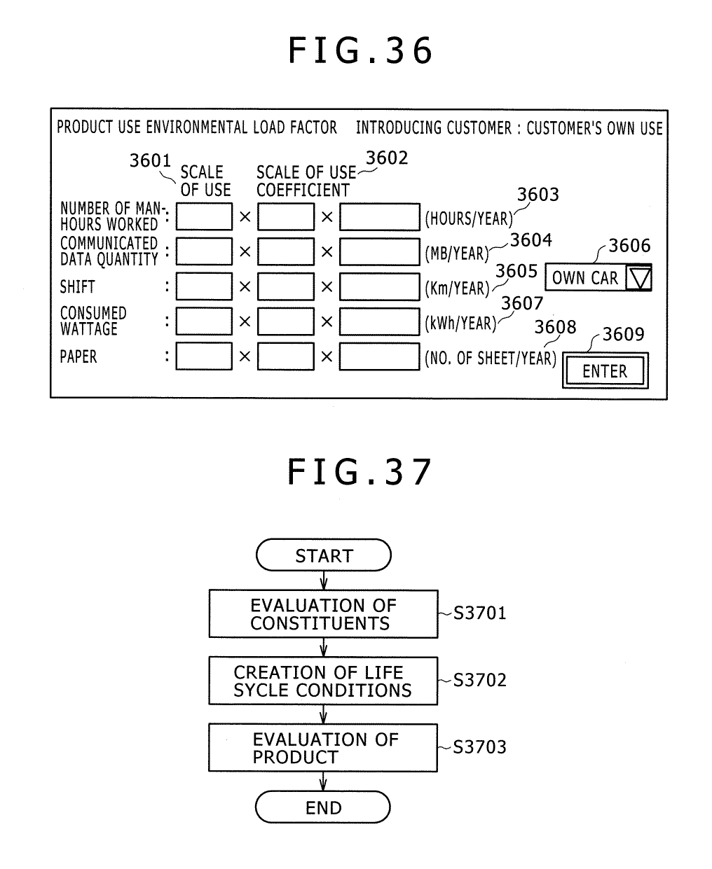

At step S408, the data in the environmental load factor storage referred to above are displayed via the output unit 160 on the time of product use environmental load factor screens shown in FIG. 34 through FIG. 36. It is to be noted that FIG. 34 will be displayed if the object of use 3301 is business operation, FIG. 35 will be if it is for management, and FIG. 36 will be if it is for a customer.

To add, all of 3401, 3501 and 3601 representing the scale of use only represent the scale of use 714 in the input information storage in the temporary information storage area 117, but none accepts correction inputting.

Whereas the following description refers to record-by-record displaying and corrective inputting, as stored in the environmental load factor storage in the temporary information storage area 117 shown in FIG. 33, by way of the screens of FIG. 34 through FIG. 36 according to the value of the object of use 3301, the different screens are treated together as the processing is all the same for any of them.

The scale of use coefficient 3402, 3502 and 3602 boxes display the scale of use coefficients 3302, 3304, 3307, 3309 and 3311 of the respectively pertinent records in this order. The number of man-hours worked 3403, 3503 and 3603 boxes display the number of man-hours worked 3303 in the pertinent record. The communicated data quantity 3404, 3504 and 3604 boxes display the communicated data quantity 3305 in the pertinent record. The shift 3405, 3505 and 3605 boxes display the shift 3308 in the pertinent record. The traffic means 3406, 3506 and 3606 boxes display the traffic means 3306 in the pertinent record as the initial value, and it is made possible to display and select as data of the pull-down menu the transport means 1801 of the transport means information table shown in FIG. 18. The paper 3408, 3508 and 3608 boxes display the paper 3312 in the pertinent record. The consumed wattage 3407, 3507 and 3607 boxes display the consumed wattage 3310 in the pertinent record. For the consumed wattage 3407, the consumed wattage 3104 of a record that is in the product compositional information table in the constituent elements information storage area 111 shown in FIG. 31 and whose type number 3102 coincides with the type number 2803 of a record that is in the product constituent elements information table and has an ID 2801 coinciding with the ID 2401 extracted at step S406 is extracted, and is multiplied by the quantity 2804. The same processing is applied to all the pertinent records in the product compositional information table and the sum of the processing results is computed and displayed.

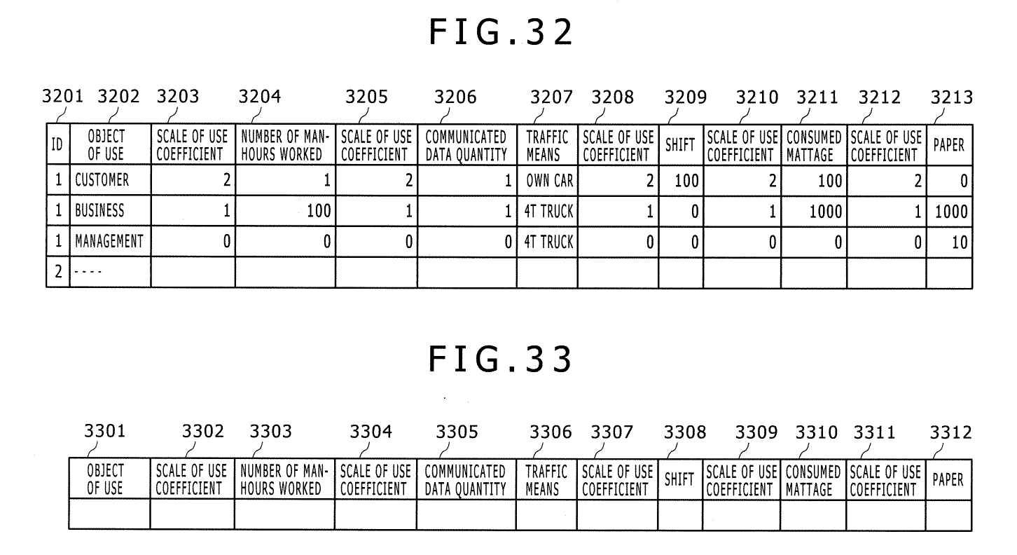

After the enter buttons 3409, 3509 and 3609 are pressed, one of the scale of use coefficients 3402, 3502 and 3602 is stored into the scale of use coefficient 3203, 3205, 3208, 3210 and 3212 boxes according to the object of use 3202 in the environmental load factor table in the evaluative information storage area 116 shown in FIG. 32 in the order of entries in the screen. Similarly thereafter, one of the numbers of man-hours worked 3403, 3503 and 3603 is stored into the number of man-hours worked 3204 box; one of the communicated data quantities 3404, 3504 and 3604 is stored into the communicated data quantity 3206 box; one of the traffic means 3406, 3506 and 3606 is stored into the traffic means 3207 box; one of the shifts 3405, 3505 and 3605 is stored into the shift 3209 box; one of the consumed wattages 3407, 3507 and 3607 is stored into the consumed wattage 3211 box; and one of the paper 3408, 3508 and 3608 is stored into the paper 3213 box. Whichever of the enter buttons 3409, 3509 and 3609 may be pressed, the next record is processed according to the object of use 3301 in a record in the environmental load factor storage, and when the records run out, the processing at step S408 is ended.

### (7) Processing to Create Records for Evaluative Information Table, Shipping Work Information Table, Transport Information Table

Next, records for the evaluative information table in the evaluative information storage area 116 shown in FIG. 9 are created, wherein the ID 901 is ID 2401. Then, data in the input information storage in the temporary information storage area 117 shown in FIG. 7 are used to enter the field of product 703 as the field of product 902, the product cost 704 as the product cost 903, the design and development cost 705 as the design and development cost 904, the shipping cost 706 as the shipping cost 905, the procurement cost 707 as the procurement cost 906, the transport cost 708 as the transport cost 907, the installation cost 709 as the installation cost 908, the start-up cost 710 as the start-up cost 909, the maintenance cost 711 as the maintenance cost 910, the collection cost 712 as the collection cost 911, the recycling cost 713 as the recycling cost 912, and the scale of use 714 as the scale of use 913. Further, the ID created at step S406 is entered as the product constitution ID 914, and that created at step S408 is entered as the environmental load factor ID 915.

Further from the shipping work information storage in the temporary information storage area 117 shown in FIG. 11 into the shipping work information table, with the ID created at step S408 being used as the ID 1001, a record is created in which the number of CDs 1002 is the number of CDs 1101, the number of paper sheets 1003 is the number of paper sheets 1102 and the number of cardboard boxes 1004 is the number of cardboard boxes 1103.

Similarly, from the transport information storage in the temporary information storage area 117 shown in FIG. 13 into the transport information table in the evaluative information storage area 116 shown in FIG. 12, with the ID created at step S408 being used as the ID 1201, two records, because there are two transport types 1202 including transport as such and collection, are created in which the type 1202 is the type 1301, the transport means 1203 is the transport means 1302, the number of units 1204 is the number of units 1303 and the distance 1205 is the distance 1304.

This completes the processing at step S301 in FIG. 3.

### (8) Processing to Compute Environmental Load

Next, environmental load computation at step S302 in FIG. 3 is processed. Here, it is processing by the environmental load computing section 135 shown in FIG. 1, and processing at steps S3701 through S3703 in FIG. 37 is accomplished.

First, the processing at step S3701 will be described. In the record in the evaluative information management table shown in FIG. 24, the ID 2401 of the latest record of the day and hour of evaluation 2407 is acquired, and is used as the ID 2801 of the product compositional information table in the evaluative information storage area 116 shown in FIG. 28.

Here, the design and development is represented by E1, the procurement by E2, the recycling by E3 and the consumed wattage by E4 as variables regarding the environmental load. Variables regarding the cost are the procurement represented by C2, the recycling by C3 and the consumed wattage by C4. Every one of these variables is 0 in its initial value.

First, the constituent elements information is searched for a record in which the type number 2803 of the product constitutional information coincides with the type number 3102 in the constituent elements information shown in FIG. 31.

Regarding the environmental load:

E1=E1+design and development load 3107×quantity 2804 [Equation 2]

E2=E2+manufacturing load 3106×quantity 2804 [Equation 3]

E3=E3+recycling load 3109×quantity 2804 [Equation 4]

The evaluation class that is the environment, the evaluation item that is the consumed wattage and the numerical value that is the consumed wattage 3104 are delivered to the environmental load computing section 135, and the result is represented by EE4:

E4=E4+EE4×quantity 2804 [Equation 5]

Regarding the cost:

C2=C2+product price 3105×quantity 2804 [Equation 6]

C3=C3+recycling cost 3108×quantity 2804 [Equation 7]

The evaluation class that is the cost, the evaluation item that is the consumed wattage and the numerical value that is the consumed wattage 3104 are delivered to the environmental load computing section 135, and the result is represented by CC4:

C4=C4+CC4×the quantity 2804 [Equation 8]

The foregoing calculations are repeated until there is no more of type number 2803 of the product constitutional information.

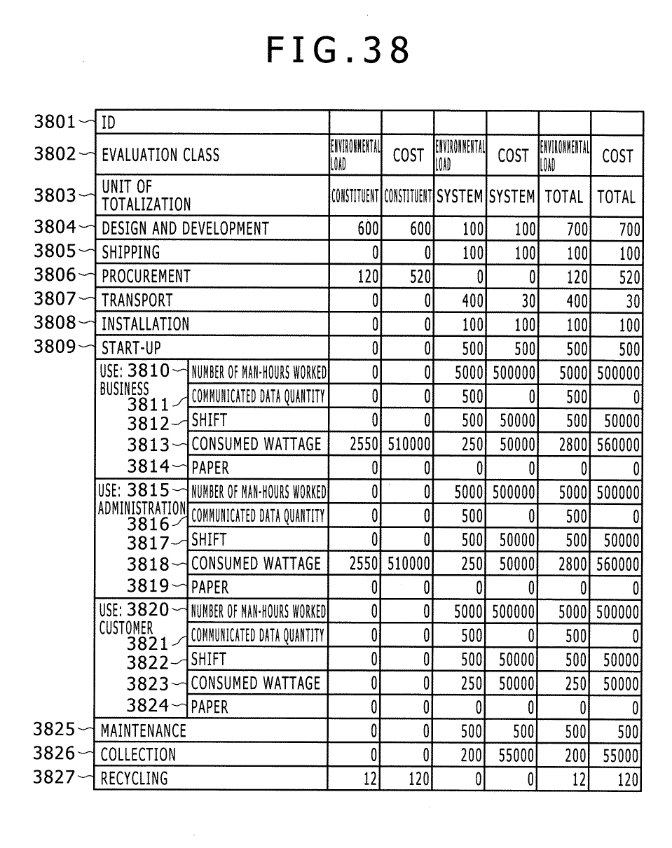

After completion, two records are created with the ID 2401 extracted in the previous processing being used as the ID 3801 in the product evaluation result table in the evaluation result storage area 118 shown in FIG. 38. One record is created having the environmental load as the evaluation class 3802 and the constituent as the unit of totalization 3803, wherein the design and development 3804 is E1, the procurement 3806 is E2, the consumed wattage 3813 is E4, the recycling 3827 is E3 and all other items are 0. The other record is created having the cost as the evaluation class 3802 and the constituent as the unit of totalization 3803, wherein the design and development 3804 is 0, the procurement 3806 is C2, the consumed wattage 3813 is C4, the recycling 3827 is C3 and all other items are 0. This completes the processing at S3701.

To add, the product evaluation result table shown in FIG. 38 includes ID 3801, evaluation class 3802, unit of totalization 3803, design and development 3804, shipping 3805, procurement 3806, transport 3807, installation 3808, start-up 3809; number of man-hours worked 3810, communicated data quantity 3811, shift 3812, consumed wattage 3813 and paper 3814, these items being applicable to business operations when in use; number of man-hours worked 3815, communicated data quantity 3816, shift 3817, consumed wattage 3818 and paper 3819, these items being applicable to administration; number of man-hours worked 3820, communicated data quantity 3821, shift 3822, consumed wattage 3823 and paper 3824, these items being applicable to the customer; maintenance 3825, collection 3826 and recycling 3827; every one of these items has an environmental load or a cost as its value.

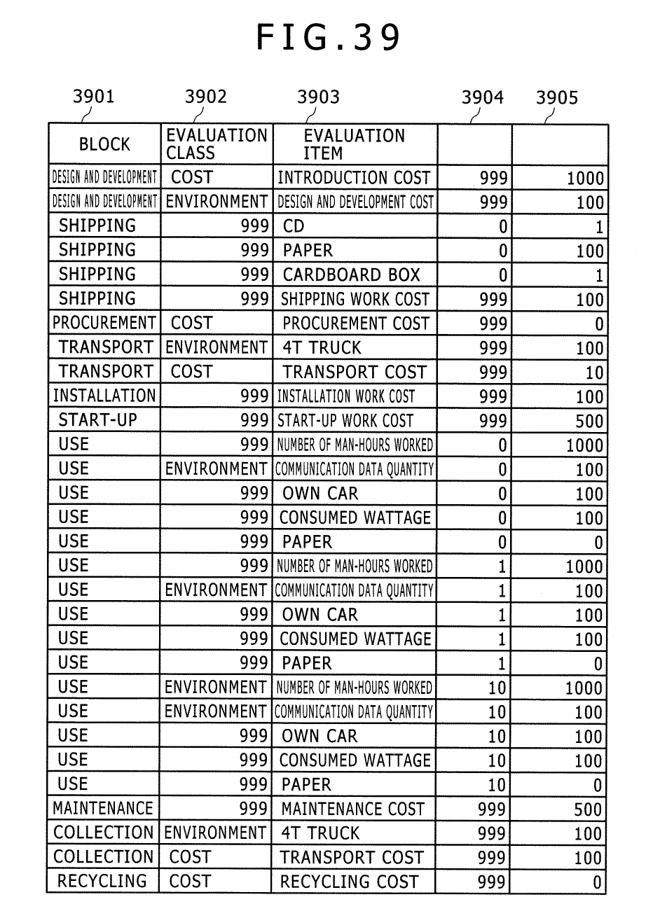

Next, life cycle documentation at step S3702 is processed. Here, the life cycle conditions of the temporary information storage area 117 shown in FIG. 39 are created from the evaluative information table shown in FIG. 9, the shipping work information table shown in FIG. 10, the transport information table shown in FIG. 12 and the environmental load factor table shown in FIG. 32.

First, in a record in the evaluative information management table shown in FIG. 24, the ID 2401 of the latest record for the day and hour of evaluation 2407 is acquired, and records respectively coinciding with the evaluative information table ID 901, the shipping work information table ID 1001 and the environmental load factor table ID 3201 are extracted. The following description is in the order of data entered in the block 3901.

To begin with, a record having design and development as the block 3901, cost as the evaluation class 3902, introduction cost as the evaluation item 3903, 999 as the division 3904 and input to the product cost 903 as the numerical value 3905, and another record having environment as the evaluation class 3902, design and development cost as the evaluation item 3903, 999 as the division 3904 and the design and development cost 904 as the numerical value 3905 are created.

Four records having shipping as the block 3901 are created. Herein, 999 is selected for the evaluation class. Where the evaluation item 3903 is CD, the numerical value 3905 is the number of CDs 1002; where the evaluation item 3903 is paper, the numerical value 3905 is the number of paper sheets 1003; and where the evaluation item 3903 is cardboard, the numerical value 3905 is the number of cardboard boxes 1004, and in every case, 0 is selected for the division 3904. Where the evaluation item 3903 is shipping work cost, the shipping cost 905 is selected for the numerical value 3905 and 999 for the division 3904. The four records are created on this basis.

One record having procurement as the block 3901 is created. Herein, cost is the evaluation class 3902, procurement cost is the evaluation item 3903, 999 is the division 3904 and the procurement cost 906 is the numerical value 3905.

Records having transport as the block 3901 are created, in which 999 is the division 3904. As regards data for the records in which transport is the type 1202 of the transport information table, where environment is the evaluation class 3902, the transport means 1203 is selected for the evaluation item 3903 and the number of units 1204×the distance 1205, for the numerical value 3905. Where cost is the evaluation class 3902, transport cost is selected for the evaluation item 3903 and transport cost 907, for the numerical value 3905.

One record having installation as the block 3901 is created. Herein, 999 is selected for both the evaluation class 3902 and the division 3904. Installation work cost is the evaluation item 3903, and installation cost 908 is the numerical value 3905.

One record having start-up as the block 3901 is created. Herein, 999 is selected for both the evaluation class 3902 and the division 3904. Start-up work cost is the evaluation item 3903, and start-up cost 909 is the numerical value 3905.

Fifteen records having use as the block 3901 are created. Where business operations is the object of use 3202, 0 is selected for the division 3904, where management is the object, 1 for the division 3904, and where the use is for the customer, 10 for the division 3904, five records being created for each object.

Each record will now be described. Where 999 is the evaluation class 3902 and the number of man-hours worked is the evaluation item 3903, the numerical value 3905 is the product of the number of man-hours worked 3204×the scale of use 913×the scale of use coefficient 3203. Only where the division 3904 is 10, environment is selected for the evaluation class 3902.

Next, where environment is the evaluation class 3902 and communicated data quantity is the evaluation item 3903, the numerical value 3905 is the product of the communicated data quantity 3206×the scale of use 913×the scale of use coefficient 3205. Where 999 is the evaluation class 3902 and the traffic means 3207 is the evaluation item 3903, the numerical value 3905 is the product of the shift 3209×the scale of use 913×the scale of use coefficient 3208. Where 999 is the evaluation class 3902 and consumed wattage is the evaluation item 3903, the numerical value 3905 is the product of the consumed wattage 3211×the scale of use 913×the scale of use coefficient 3210. Where 999 is the evaluation class 3902 and paper is the evaluation item 3903, the numerical value 3905 is the product of the paper 3213×the scale of use 913×the scale of use coefficient 3212.

A record having maintenance as the block 3901 is created. Herein, 999 is selected for both the evaluation class 3902 and the division 3904. The record is created in which maintenance cost is the evaluation item 3903 and the maintenance cost 910 is the numerical value 3905.

Records having collection as the block 3901 are created, in which 999 is the division 3904. Where environment is the evaluation class 3902 as record data for the transport information table in which collection is the type 1202, the transport means 1203 is the evaluation item 3903, the numerical value 3905 is the product of the number of units 1204×the distance 1205. Where cost is the evaluation class 3902, transport cost is the evaluation item 3903, and collection cost 911 is the numerical value 3905.

One record having recycling as the block 3901 is created. Herein, cost is the evaluation class 3902, recycling cost is the evaluation item 3903, 999 is the division 3904 and the recycling cost 912 is the numerical value 3905.

This completes the processing at step S3702. Now, the processing of production evaluation at step 3703 will be described. The environmental load and cost of a given system product are evaluated according to the life cycle conditions shown in FIG. 39, and the product evaluation result table shown in FIG. 38 is created according to the result of totalization.

Two records are created with the ID 2401 extracted in the previous processing being used as the ID 3801, wherein environmental load and cost is the evaluation class 3802 and system is the unit of totalization 3803.

Data converted by the environmental load computing section 135 are inputted to the lines from 3803 through 3826 in the product evaluation result table shown in FIG. 38 to the item of 3826 according to the name of the block 3901 in the life cycle conditions shown in FIG. 39.

It has to be noted, however, that when use is entered in the block 3901, 0 entered in the division 3904 means use for business operations and inputs are to the lines from 3810 through 3814; 1 entered in the division 3901 means use for administration and inputs are to the lines from 3815 through 3818; and 10 entered in the division 3904 means use by customer and inputs are to the lines from 3820 through 3824.

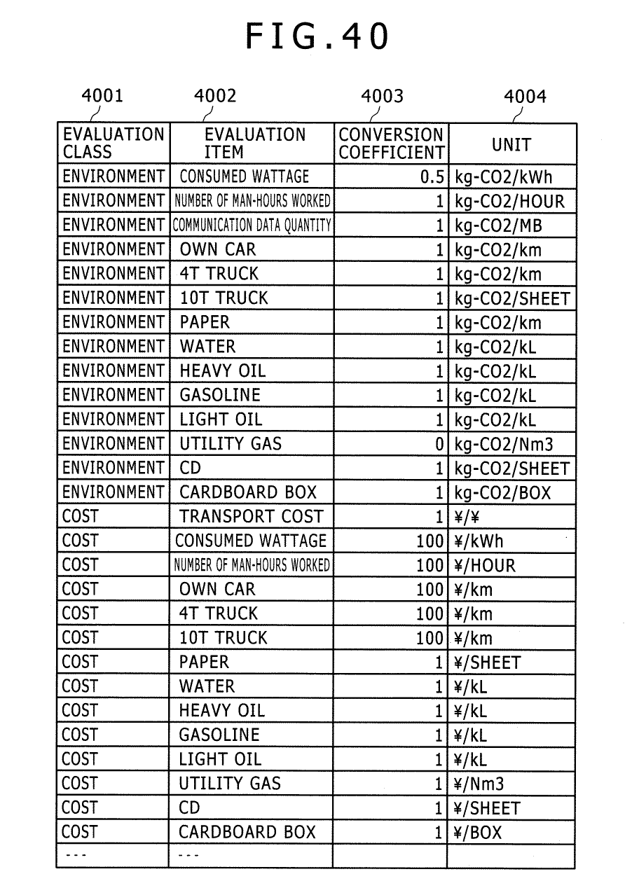

Next, when the environmental load computing section 135, as its basic processing, receives the evaluation class 3902, the evaluation item 3903 and the numerical value 3905 together with the environmental load and the cost, searches for a conversion factor 4003 corresponding to the evaluation class 4001 and the evaluation item 4002 in the environmental load-to-cost conversion table stored in the environmental load-to-cost conversion information storage area 112 shown in FIG. 40, and returns a result obtained by multiplying the numerical value 3905 by the conversion factor 4003. Where 999 is entered as the evaluation class 3902, it means both environment and cost, and processing is accomplished for both.

Where the entry in the block 3901 is anything else than use and multiple records are present, the results of conversion are totalized separately for environment and cost.

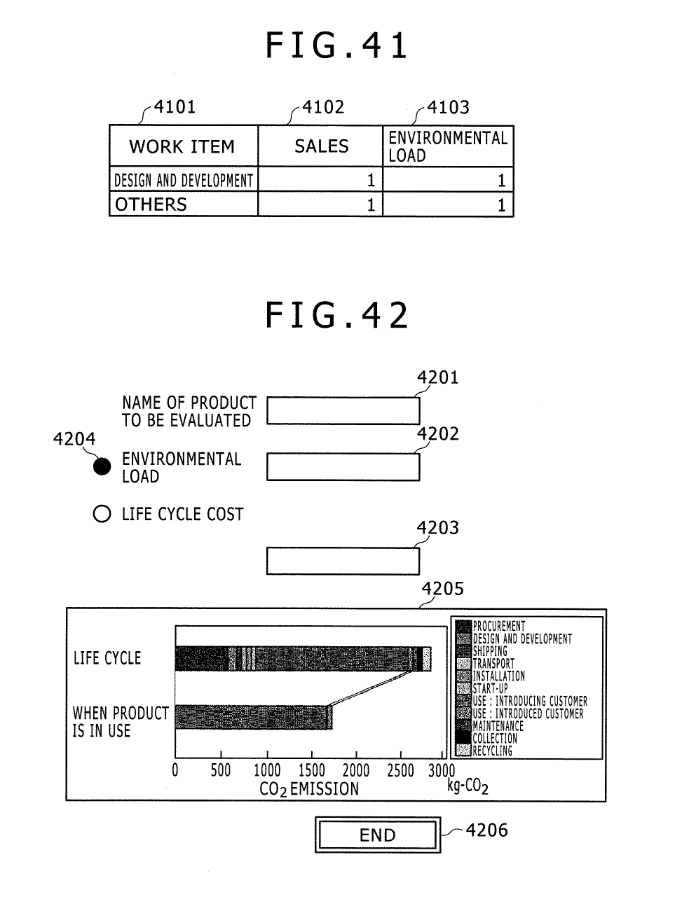

However, where the environmental load is to be computed with 999 being entered as the evaluation class 3902 and 999 as the division 3904, upon receipt of the evaluation class 3903 and the numerical value 3905, the quotient of division of the environmental load 4103 by the sales 4102 according to the human work conversion factor stored in the business operator information storage area 113 shown in FIG. 41 as the environmental load regarding the design and development, shipping, installation, start-up, and maintenance works correspondingly to the work item 4101 is returned. Although other work items than design and development are collectively referred to as others in the context of this embodiment of the invention, every item may as well be defined separately. Regarding the cost, the numerical value 3905 is returned as it is.

It has to be noted that, however, when use and maintenance are entered in the block 3901, in the record in the evaluative information management table shown in FIG. 24, the product of multiplication of the record matching the ID 2401 extracted at step S3701 by the number of years of product use 2403 as the number of years of use of the system product is selected as the input value for each item. Further, since the introduction cost is a numerical value for confirmation, the foregoing processing is skipped only when design and development is entered as the block 3901 and cost is as the evaluation class 3902.

Each of these results is entered into the pertinent item in environmental loads and costs listed in the evaluation class 3801 category.

After completing the processing described above to all the records of the life cycle conditions shown in FIG. 39, two records are created in which ID, the environmental load and cost as the evaluation class 3801 and the total as the unit of totalization 3802 are entered. Then entries in which the evaluation classes 3802 coincide, the constituent is the unit of totalization 3803 and entries from 3804 through 3827 of the system are added item by item, and as data from 3804 through 3827 the total is entered as the unit of totalization 1902.

This completes the processing at step S3703, and the processing at step S302 is also completed.

### (9) Processing of Evaluation Result Output

Next, processing of evaluation result output S303 will be described. Herein, the results preserved in the product evaluation result table are processed by the evaluation result output section 138 and displayed via the output unit 160.

First, out of the records in the evaluative information management table shown in FIG. 24, the ID 2401 of the latest record of the day and hour of evaluation 2407 is acquired, and the record of the ID 3801 and the total entered as the unit of totalization 3803 in the product evaluation result table coinciding with it are extracted. Whereas two records, in one of which environmental load is entered and in the other of which cost is entered as the evaluation class are extracted, the totalized values from the design and development 3804 through the recycling 3827 are computed in each record.

Then on the product evaluation output table screen shown in FIG. 42, the name of product to be evaluated 2402 of the ID 2401 record in the evaluative information management table is displayed as the name of product to be evaluated 4201, the environmental load of the totalized value as the environmental load 4202, and the cost as the cost 4203.

To add, 4204 denotes the button for selection between environmental load and cost, and the selected object is displayed on the graph 4205. In this case, for both environmental load and cost, all the entries from the design and development 3804 through the recycling 3827 are displayed item by item as elements of the life cycle. Also, the entries from the number of man-hours worked 3810 through the paper 3824 are displayed item by item as the time of product use.

When the end 4206 is inputted via the input unit 150, processing of the evaluation result output S303 is ended.

### (10) Processing of Evaluation Object Selection

Then, evaluation object selection S304 shown in FIG. 3 will be described. Here, it is processing by the object of comparison input section 136. As stated earlier, processing at this and subsequent steps is to subject the multiple products evaluated from S301 through S303 to comparative evaluation and to compute their environmental load reducing effects.

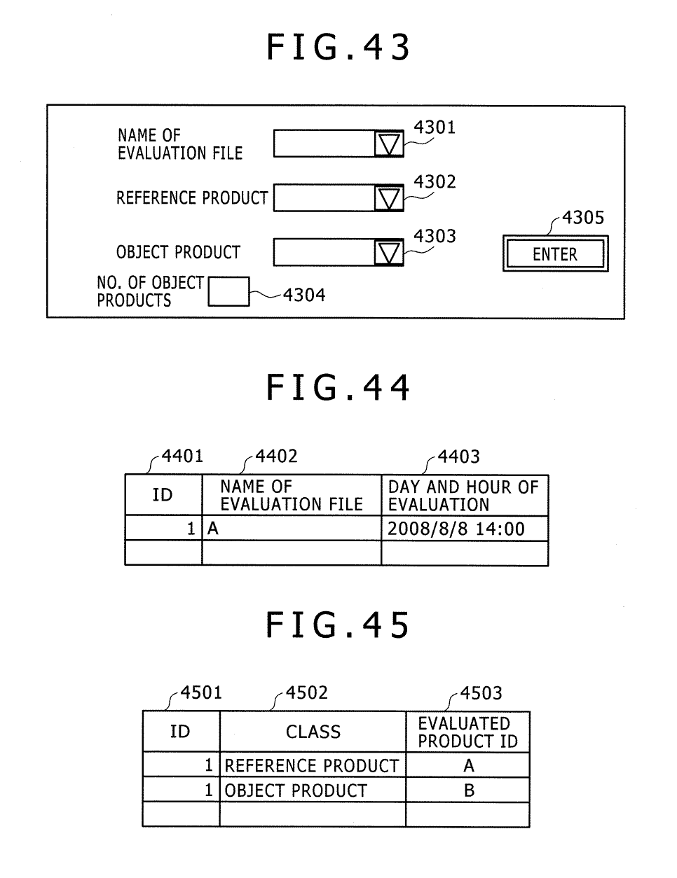

FIG. 43 shows an evaluation object selection table. It comprises the evaluation object file name 4301, the reference product 4302 and the object product 4303. While a file name can be directly entered as the evaluation object file name 4301, an option is also available to display, for the convenience of referencing past data, the evaluation object file name 4402 in the comparative evaluation management table shown in FIG. 44 by pull-down to select it for the purpose here. There also is an option to display the name of product to be evaluated 2402 in the evaluative information management table shown in FIG. 24 by pull-down to select it as the reference product 4302 and the comparable object product 4303.

To add, where the evaluation object file name 4302 is selected, instead of directly inputting a new file name, for the evaluation object file name 4301 out of the ID 4501 record in the comparative evaluation object product management table shown in FIG. 45 corresponding to the ID 4401, the name of product to be evaluated 2402 can be made selectable from the ID 2401 record in the evaluative information management table corresponding to the product to be evaluated ID 4503 according to the product class 4502 instead of displaying by pull-down the name of product to be evaluated 2402 in the evaluative information management table as the reference product 4302 and the object product 4303. In both cases, one product can be selected as the reference product 4302 and multiple products as the object product 4303. For this reason, when a numerical value is entered as the number of object products 4304, multiple object products 4303 are created to be followed by the same processing as the foregoing. As the initial value of the number of object products 4304, 1 is displayed.

If in the foregoing the evaluation object file name 4301 is newly inputted after the enter button 4305 is pressed, a new ID 4401 is issued, and a record is created in which the evaluation object file name 4301 is entered as the evaluation object file name 4402 and the system time as the day and hour of evaluation 4403.

Further, a required number of records, bearing the ID 4401 as the ID 4501, are created whose ID 2401 is consistent with the reference product entered as the product class 4502 and the reference product 4302 entered as the product to be evaluated ID 4503 and further is consistent with the object product entered as the product class 4502 and the object product 4303 entered as the product to be evaluated ID 4503, and processing at S304 is thereby ended.

The comparative evaluation management table shown in FIG. 44 and the comparative evaluation object product management table shown in FIG. 45 are stored in the evaluation result storage area 118.

### (11) Processing of Comparison Result Output

Finally, the processing of comparison result output S305 will be described. The processing is accomplished by the environmental load reducing effect computing section 137 and the evaluation result output section 138. As stated earlier, there is only one object product.

First, the environmental load reducing effect computing section 137 extracts the record of the ID 3801 of the product evaluation result table corresponding to the product to be evaluated ID 4503 and the total entered as the unit of totalization 3803 coinciding with the ID 4401 of the comparative evaluation management table shown in FIG. 44 created at step S304 out of the ID 4501 record of the comparative evaluation object product management table shown in FIG. 45 according to the product class 4502.

Whereas two records in which environmental load and cost are the evaluation class 3802 separately for the reference product and the object product, the totals from the design and development 3804 through the recycling 3827 are computed for each record. These totals are used as the reference product life cycle environment, the reference product life cycle cost, the object product life cycle environment and the object product life cycle cost.

Similarly, for each of the same records, the totalized value of the paper 3824 is computed from the number of man-hours worked 3810. Each of the totalized values is used as the environment at the time of using the reference product, the cost at the time of using the reference product, the environment at the time of using the object product and the cost at the time of using the object product.

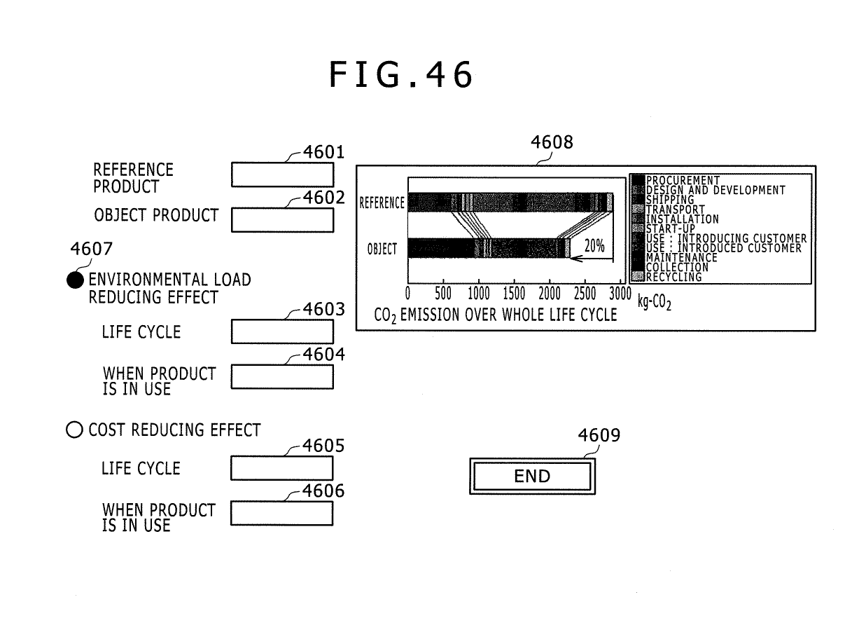

Then, the evaluation result output section 138 displays in the product comparative evaluation output table shown in FIG. 46 the name of product to be evaluated 2402 of the ID 2401 record in the evaluative information management table coinciding with the product to be evaluated ID 4503 previously extracted, in the reference product 4601 box if the reference product is entered as the product class 4502 or in the object product 4602 box if the object product is entered as the product class 4502.

Regarding the environmental load reducing effect, (the reference product life cycle environment minus the object product life cycle environment) is displayed in the life cycle 4603 box and simultaneously (the environment when using the reference product minus the environment when using the object product) is displayed in the time of using the product 4604 box.

Next, regarding the cost reducing effect, (the reference product life cycle cost minus the object product life cycle cost) is displayed in the life cycle 4605 box and (the cost when using the reference product minus the cost when using the object product) is displayed in the time of using the product 4606 box.

Regarding the environmental load reducing effect and the cost reducing effect discussed above, where multiple object products are involved, the reference product and the object product are compared as many times as the number of object products.

To add, 4607 denotes the button for selection between the environmental load reducing effect and the cost reducing effect, and the result of selection is displayed in the graph 4608.

When the environmental load reducing effect is selected here, out of the two records from the ID 3801 of the product evaluation result table extracted at S302, in which the total is entered as the unit of totalization 3803 and the environmental load is entered as the evaluation class 3802, items from the design and development 3804 through the recycling 3827 of the record of the reference product are displayed item by item as references for the graph 4608. Similarly, items from the record of the object product are displayed as the objects of the graph 4608.

Or when the cost reducing effect is selected, out of the two records from the ID 3801 of the product evaluation result table extracted at S302, in which the total is entered as the unit of totalization 3803 and the cost is entered as the evaluation class 3802, similarly to the foregoing, items from the design and development 3804 through the recycling 3827 of the record of the reference product are displayed item by item as references for the graph 4608. Similarly, items from the record of the object product are displayed as the objects of the graph 4608.

Incidentally, the graph 4608 may as well be displayed in a tabular form at the output terminal. Or the graph and the table may as well be outputted to a medium, such as paper.

When the end 4609 is inputted via the input unit 150, processing at S305 is ended, and the whole sequence of processing by the environmental information documenting apparatus 100 in this mode of embodying the invention is completed.

What is claimed is:

1. An environmental information documenting apparatus comprising:
a storage unit that stores an evaluative information table, a transport information table, a product compositional information table, and an environmental load factor table, in each of which the cost and the scale of use of system products, each being a combination of plurality of hardware and/or software products, at different stages the life cycle thereof is assigned IDs sorted by product class, a shipping work information table in each record corresponds to one of the IDs, and a constituent elements information table, an evaluative information management table and a product evaluation result table;
a control unit; and
an input unit and an output unit that constitute user interfaces and performs communication with an external system,
wherein the control unit includes:
a section that at least accepts from a user interface indicators representing the name of a product to be evaluated, the product field, the total cost of the product and the scale of use of the product, and extracts from the evaluative information table the record closest within a prescribed tolerance to the accepted product cost and scale of use;
a section that searches each table according to the ID of the extracted record, presents to the user interfaces the cost of the pertinent system product at each stage of the life cycle thereof, accepts a corrected input from the user and records the corrected cost;
a section that displays a product use environmental load factor screen on the user interface, presents information on the scale of use, the scale of use coefficient, and the initial value regarding factors including the number of man-hours worked, communicated data quantity, shift, consumed wattage and paper retrieved from the environmental load factor table and, after accepting a corrected input from the user, records the data;
a section that searches each record in the constituent elements information table and the product compositional information table matching the record of the extracted evaluative information table, computes the environmental load at each stage of the life cycle, and creates a product evaluation result table for each stage of the life cycle for each evaluation class of the environmental load and the cost and for each unit of totalization of the constituents, the system and the total; and
a section that outputs a product evaluation output table screen from the output unit, arranges on the screen a selection button for the name of product to be evaluated, the environmental load and the cost on the screen, accepts the input of the selection made therewith, and displays a graph of the environmental load or the cost at each stage of the life cycle and of the product use.

2. The environmental information documenting apparatus according to claim 1, wherein the control unit further has:
a section that reads out of the evaluative information table a record of the same field of product as the extracted record, computes a line form in which, out of dotted sequences plotted according to a coordinate system of (the scales of use and the stage-by-stage costs in the life cycle), only those satisfying a proportional relationship are left, computes the stage-by-stage cost of the life cycle according to the scales of use, and corrects the pertinent stage-by-stage cost of the life cycle.

3. The environmental information documenting apparatus according to claim 1, wherein the control unit has: in place of the section that displays a graph of the environmental load or the cost,
a section that outputs an evaluation object selection table from the output unit, accepts on the screen inputting by the user of the evaluation object file name, the reference product and the object product, manages the same as stored in the table, outputs a product comparative evaluation output table in accordance with designation of an evaluation object file name by the user, and comparatively displays a graph of the environmental load or the cost of each of the reference product and the object product at each stage of the life cycle of the same according to selective inputting of the environmental load or the cost by the user.

4. The environmental information documenting apparatus according to claim 1, wherein the life cycle is divided into the stages of design and development, shipping, procurement, transport, installation, start-up, use, maintenance, collection and recycling in evaluating the environmental loads of system products.

5. An environmental information documenting method by which an environmental information documenting apparatus including: a storage unit that stores an evaluative information table, a transport information table, a product compositional information table, and an environmental load factor table, in each of which the cost and the scale of use of system products, each being a combination of plurality of hardware and/or software products, at different stages the life cycle thereof is assigned IDs sorted by product class, a shipping work information table in each record corresponds to one of the IDs, and a constituent elements information table, an evaluative information management table and a product evaluation result table; a control unit; and an input unit and an output unit that constitute user interfaces and performs communication with an external system,
wherein the control unit executes the steps of:
at least accepting from a user interface indicators representing the name of a product to be evaluated, the product field, the total cost of the product and the scale of use of the product, and extracting from the evaluative information table the record closest within a prescribed tolerance to the accepted product cost and scale of use;
searching each table according to the ID of the extracted record, presenting to the user interfaces the cost of the pertinent system product at each stage of the life cycle thereof, accepting a corrected input from the user and recording the corrected cost;
displaying a product use environmental load factor screen on the user interface, presenting information on the scale of use, the scale of use coefficient, and the initial value regarding factors including the number of man-hours worked, communicated data quantity, shift, consumed wattage and paper retrieved from the environmental load factor table and, after accepting a corrected input from the user, recording the data;
searching each record in the constituent elements information table and the product compositional information table matching the record of the extracted evaluative information table, computing the environmental load at each stage of the life cycle, and creating a product evaluation result table for each stage of the life cycle for each evaluation class of the environmental load and the cost and for each unit of totalization of the constituents, the system and the total; and
outputting a product evaluation output table screen from the output unit, arranging on the screen a selection button for the name of product to be evaluated, the environmental load and the cost on the screen, accepting the input of the selection made therewith, and displaying a graph of the environmental load or the cost at each stage of the life cycle and of the product use.

6. The environmental information documenting method according to claim 5, wherein the control unit further executes the step of: reading out of the evaluative information table a record of the same field of product as the extracted record; computing a line form in which, out of dotted sequences plotted according to a coordinate system of (the scales of use and the stage-by-stage costs in the life cycle), only those satisfying a proportional relationship are left; computing the stage-by-stage cost of the life cycle according to the scales of use; and correcting the pertinent stage-by-stage cost of the life cycle.

7. The environmental information documenting method according to claim 5, wherein the control unit executes the steps of: in place of displaying a graph of the environmental load or the cost,
outputting an evaluation object selection table from the output unit; accepting on the screen inputting by the user of the evaluation object file name, the reference product and the object product; managing the same as stored in the table; outputting a product comparative evaluation output table in accordance with designation of an evaluation object file name by the user; and comparatively displaying a graph of the environmental load or the cost of each of the reference product and the object product at each stage of the life cycle of the same according to selective inputting of the environmental load or the cost by the user.

8. The environmental information documenting method according to claim 5, wherein the life cycle is divided into the stages of design and development, shipping, procurement, transport, installation, start-up, use, maintenance, collection and recycling in evaluating the environmental loads of system products.
